(19) United States
(12) Patent Application Publication
(10) Pub. No.: US 2022/0292665 A1
(43) Pub. Date: Sep. 15, 2022

(54) WORKPIECE SURFACE DEFECT DETECTION DEVICE AND DETECTION METHOD, WORKPIECE SURFACE INSPECTION SYSTEM, AND PROGRAM

(71) Applicant: Konica Minolta, Inc., Tokyo (JP)

(72) Inventors: SHOTA UEKI, Toyonaka-shi, Osaka (JP); AKIRA YAHASHI, Higashinada-ku, Kobe-shi, Hyogo (JP); YOSHIROH NAGAI, Nishinomiya-shi, Hyogo (JP); RYUICHI YOSHIDA, Kita-ku, Sakai-shi, Osaka (JP)

(21) Appl. No.: 17/639,731

(22) PCT Filed: Sep. 4, 2020
(86) PCT No.: PCT/JP2020/033629

§ 371 Date: Mar. 2, 2022

(30) Foreign Application Priority Data
Oct. 2, 2019 (JP) 2019-182098

(51) Int. Cl. G06T 7/00; G06T 3/40; G06V 10/141

(52) U.S. Cl. CPC G06T 7/0004; G06T 3/4038; G06V 10/141; G06T 2207/10152; G06T 2207/30156; G06T 2207/30164; G06T 2207/30252

(57) ABSTRACT

A synthetic image is created by calculating a statistical variation value in a plurality of images using the plurality of images obtained by an image-capturing means (8) continuously capturing a workpiece (1) in a state where the workpiece is illuminated by a lighting device (6) that causes a periodic luminance change at a same position of the workpiece that is a detection target of a surface defect, the plurality of images being obtained in one period of the periodic luminance change, and a defect is detected based on a synthetic image created by the image synthesis means.

### TECHNICAL FIELD

The present invention relates to a workpiece surface defect detection device and a detection method, a workpiece surface inspection system, and a program that create a synthetic image based on a plurality of images obtained by an image-capturing means and detect a surface defect based on this synthetic image when irradiating a workpiece such as a vehicle body that is a detection target for a surface defect on a measured site such as a painted surface of the workpiece with illumination light that causes a periodic luminance change such as a bright and dark pattern, for example.

### BACKGROUND ART

In the method of creating a synthetic image by synthesizing a plurality of images and inspecting the surface of a workpiece, in order to shorten the processing time, it is necessary to create a synthetic image from a small number of images and to maintain the quality as an inspection image. As a synthetic image used in such an inspection method, a synthetic image created using an upper limit value and a lower limit value or a difference between the upper limit value and the lower limit value is conventionally known. For example, Patent Literature 1 discloses a technique of generating a new image using at least any of an amplitude width, a mean value, a lower limit value and a phase difference, and an upper limit value and contrast of periodic luminance change, and detecting a defect.

### CITATION LIST

### Patent Literature

Patent Literature 1: Japanese Patent No. 5994419

### SUMMARY OF INVENTION

### Technical Problem

However, there is a problem that the synthetic image used in the conventional inspection methods including the inspection method described in Patent Literature 1 has a high sensitivity to singly occurring noise (low S/N ratio), and the defect detection accuracy is not improved when the number of images to be synthesized becomes equal to or greater than a certain number. Moreover, image synthesis using the amplitude value and the phase value also has a problem that the calculation cost increases.

This invention has been made in view of such a technical background, and an object of the present invention is to provide a workpiece surface defect detection device and a detection method, a workpiece surface inspection system, and a program that can detect a surface defect of a workpiece by creating a synthetic image having a high S/N ratio and high defect detection accuracy even when the number of images is small

### Solution to Problem

The above object is achieved by the following means.

(1) A workpiece surface defect detection device including: an image synthesis means for creating a synthetic image by calculating a statistical variation value in a plurality of images using the plurality of images obtained by an image-capturing means continuously capturing a workpiece in a state where the workpiece is illuminated by a lighting device that causes a periodic luminance change at a same position of the workpiece that is a detection target of a surface defect, the plurality of images being obtained in one period of the periodic luminance change; and a detection means for detecting a defect based on a synthetic image created by the image synthesis means.

(2) The workpiece surface defect detection device according to the item 1, in which the statistical variation value is at least any of a variance, a standard deviation, and a half width.

(3) The surface defect detection device according to the item 1 or 2, in which the image synthesis means performs calculation of the statistical variation value for each pixel and performs calculation for an optimal sampling candidate selected for each pixel of the plurality of images.

(4) The surface defect detection device according to the item 3, in which the image synthesis means calculates a variation value after excluding, from the plurality of images, a sampling value of an intermediate gradation that becomes a variation value reduction factor in each pixel, and adopts the variation value as a variation value for the pixel.

(5) A workpiece surface inspection system including: a lighting device that causes a periodic luminance change at a same position of a workpiece that is a detection target for a surface defect; an image-capturing means for continuously capturing the workpiece in a state where the workpiece is illuminated by the lighting device; and the workpiece surface defect detection device according to any of the items 1 to 4.

(6) A workpiece surface defect detection method, in which a workpiece surface defect detection device executes: an image synthesis step of creating a synthetic image by calculating a statistical variation value in a plurality of images using the plurality of images obtained by an image-capturing means continuously capturing a workpiece in a state where the workpiece is illuminated by a lighting device that causes a periodic luminance change at a same position of the workpiece that is a detection target of a surface defect, the plurality of images being obtained in one period of the periodic luminance change; and a detection step of detecting a defect based on a synthetic image created by the image synthesis step.

(7) The workpiece surface defect detection method according to the item 6, in which the statistical variation value is at least any of a variance, a standard deviation, and a half width.

(8) The workpiece surface defect detection method according to the item 6 or 7, in which in the image synthesis step, calculation of the statistical variation value is performed for each pixel, and is performed for an optimal sampling candidate selected for each pixel of the plurality of images.

(9) The workpiece surface defect detection method according to the item 8, in which in the image synthesis step, a variation value is calculated after excluding, from the plurality of images, a sampling value of an intermediate gradation that becomes a variation value reduction factor in each pixel, and is adopted as a variation value for the pixel.

(10) A program for causing a computer to execute the workpiece surface defect detection method according to any of the items 6 to 9.

### Advantageous Effects of Invention

According to the invention described in the items (1), (5), and (6), a synthetic image is created by calculating a statistical variation value in a plurality of images using the plurality of images obtained in one period of a periodic luminance change, and a defect is detected based on this created synthetic image. Therefore, even if the number of images that become a synthesis target is small, it is possible to create a synthetic image having a high S/N ratio of defect detection. By using this synthetic image, it is possible to perform a highly accurate defect detection, to reduce detection of unnecessary defect candidates, and to prevent overlooking of detection of necessary defects. Moreover, the cost becomes lower than that in a case of creating a synthetic image using a maximum value, a minimum value, or the like.

According to the invention described in the items (2) and (7), a synthetic image is created by calculating at least any of a variance, a standard deviation, and a half width.

According to the invention described in the items (3) and (8), calculation of the statistical variation value is performed for each pixel, and is performed for an optimal sampling candidate selected for each pixel of the plurality of images. Therefore, particularly when the number of images to be synthesized is small, calculation of the statistical variation value is performed only by an optimal sampling candidate, and it is possible to suppress an influence of a pixel excluded from sampling candidates.

According to the invention described in the items (4) and (9), since a variation value is calculated after excluding, from the plurality of images, a sampling value of an intermediate gradation that becomes a variation value reduction factor in each pixel, and is adopted as a variation value for the pixel, it is possible to create a synthetic image having a higher S/N ratio.

According to the invention described in the item (10), it is possible to cause a computer to execute processing of creating a synthetic image by calculating a statistical variation value in a plurality of images using the plurality of images obtained in one period of a periodic luminance change, and detecting a defect based on this created synthetic image.

### BRIEF DESCRIPTION OF DRAWINGS

FIG. 1 is a plan view illustrating a configuration example of a workpiece surface inspection system according to an embodiment of the present invention.

FIG. 2 is a vertical cross-sectional view of a lighting frame when viewed from the front in a traveling direction of a workpiece.

FIG. 3 is a vertical cross-sectional view of a camera frame when viewed from the front in a traveling direction of a workpiece.

FIG. 4 is a plan view illustrating an electrical configuration of the workpiece surface inspection system illustrated in FIG. 1.

FIG. 5 is a flowchart illustrating processing of an entire workpiece surface defect inspection system.

FIG. 6(A) is images continuously acquired in time series from one camera; FIG. 6(B) is a view illustrating a state in which a coordinate of a temporary defect candidate is estimated in a subsequent image to the first image in FIG. 6(A); FIG. 6(C) is a view illustrating processing of creating a synthetic image by superimposing images of an estimated region image group; and FIG. 6(D) is a view illustrating another processing of creating a synthetic image by superimposing images of an estimated region image group.

FIG. 7 is a view for explaining processing of correcting center coordinates of an estimated region image according to a position of a defect candidate from a boundary between a bright band part and a dark band part in the image.

FIGS. 8(A) to 8(D) are views illustrating processing of creating a synthetic image by superimposing images of an estimated region image group in different aspects.

FIG. 9 is a view for explaining an example of extraction processing of a temporary defect candidate.

FIG. 10 is a flowchart illustrating contents of first surface defect detection processing executed by a defect detection PC.

FIG. 11 is a flowchart for explaining in more detail the matching processing in step S17 of FIG. 10.

FIG. 12 is a flowchart for explaining a modification of the matching processing in step S17 of FIG. 10.

FIG. 13 is a flowchart illustrating details of steps S12 to S18 of the flowchart of FIG. 10.

FIG. 14 is a flowchart illustrating second surface defect detection processing executed by the defect detection PC.

FIG. 15 is a flowchart illustrating details of steps S12 to S18 of the flowchart of FIG. 14.

FIG. 16 is a view for explaining third surface defect detection processing, and is a view illustrating a plurality of (two in this example) images continuously acquired in time series.

FIG. 17 is a graph illustrating an example of a relationship between a position of a workpiece (vehicle body) and an image plane displacement amount.

FIG. 18 is a flowchart illustrating contents of third surface defect detection processing executed by the defect detection PC.

FIG. 19 is a flowchart illustrating details of steps S32 to S40 of the flowchart of FIG. 18.

FIG. 20 is a flowchart illustrating creation processing of a standard deviation image.

FIG. 21 is a graph illustrating illuminance with respect to a workpiece of a lighting device that performs illumination of a bright and dark pattern.

FIG. 22 is a flowchart illustrating another example of creation processing of a standard deviation image.

FIG. 23 is a flowchart illustrating another example of creation processing of a standard deviation image.

### DESCRIPTION OF EMBODIMENTS

Embodiments of the present invention will be described below with reference to the drawings.

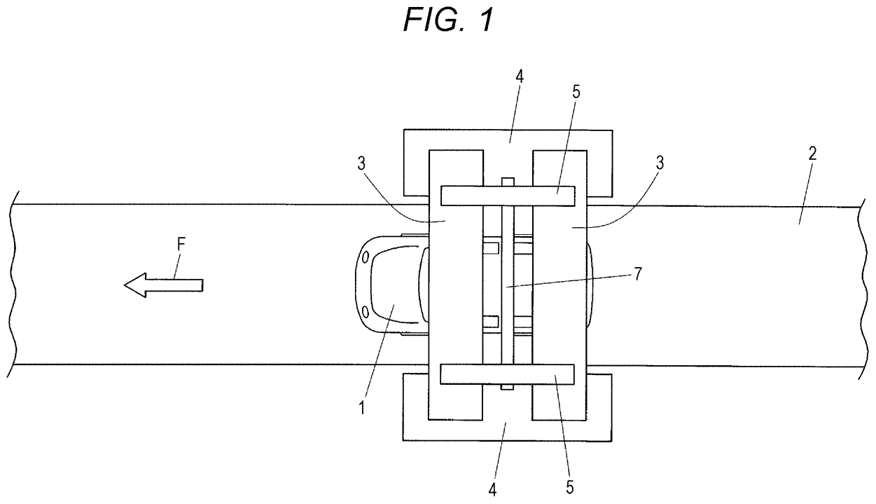

FIG. 1 is a plan view illustrating a configuration example of a workpiece surface inspection system according to an embodiment of the present invention. In this embodiment, a case where a workpiece 1 is a vehicle body, a measured site of the workpiece 1 is a painted vehicle body surface, and a surface defect of the painted surface is detected will be described. In general, the vehicle body surface is subjected to base treatment, metallic painting, clear painting, or the like, and formed with a painted film layer having a multilayer structure. An uneven defect occurs in the uppermost clear layer due to an influence of foreign matters or the like during painting. This embodiment is applied to detection of such a defect, but the workpiece 1 is not limited to the vehicle body, and may be a workpiece other than the vehicle body. The measured site may be a surface other than the painted surface.

This inspection system includes a workpiece movement mechanism 2 that continuously moves the workpiece 1 at a predetermined speed to an arrow F direction. In an intermediate part in a length direction of the workpiece movement mechanism 2, two lighting frames 3 and 3 are attached front and rear of the movement direction of the workpiece in a state where both lower end parts in a direction orthogonal to the movement direction of the workpiece are fixed to support bases 4 and 4. The lighting frames 3 and 3 are coupled to each other by two coupling members 5 and 5. The number of lighting frames is not limited to two.

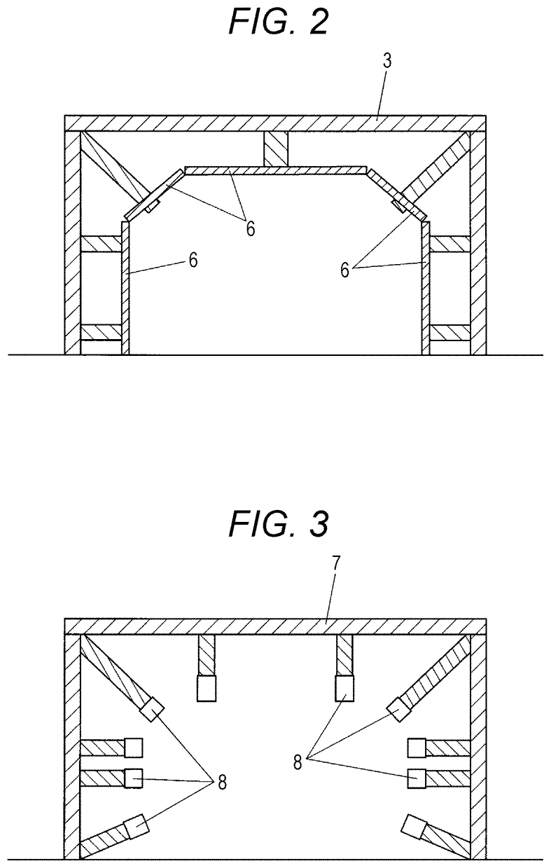

Each lighting frame 3 is formed in a gate shape as illustrated in the vertical cross-sectional view of FIG. 2 as viewed from the front in the traveling direction of the vehicle body, and a lighting unit 6 for lighting the workpiece 1 is attached to each lighting frame 3. In this embodiment, the lighting unit 6 includes a linear lighting section attached so as to surround the peripheral surface excluding the lower surface of the workpiece 1 along the inner shape of the lighting frame 3, and a plurality of these linear lighting sections are attached to the lighting frame 3 at equal intervals in the movement direction of the workpiece 1. Therefore, the lighting unit 6 diffusely lights the workpiece with illumination light of a bright and dark fringe pattern including a lighting section and a non-lighting section that are alternately present in the movement direction of the workpiece 1. The lighting unit may have a curved surface.

A camera frame 7 is attached to an intermediate part of the two front and rear lighting frames 3 and 3 in a state where both lower end parts in a direction orthogonal to the movement direction of the workpiece are fixed to the support bases 4 and 4. The camera frame 7 is formed in a gate shape as illustrated in the vertical cross-sectional view of FIG. 3 as viewed from the front in the traveling direction of the workpiece 1, and attached with a plurality of cameras 8 as image-capturing means along the inner shape of the camera frame 7 so as to surround the peripheral surface excluding the lower surface of the workpiece 1.

With such a configuration, in a state where the workpiece 1 is diffusely lighted by the illumination light of the bright and dark fringe pattern by the lighting unit 6 while the workpiece 1 is moved at a predetermined speed by the workpiece movement mechanism 2, each part in the circumferential direction of the workpiece 1 is continuously captured as a measured site by the plurality of cameras 8 attached to the camera frame 7. Image-capturing is performed such that most of the image-capturing ranges overlap in the preceding and subsequent image-capturing. Due to this, each camera 8 outputs a plurality of images in which the position of the measured site of the workpiece 1 is continuously shifted in the movement direction of the workpiece 1.

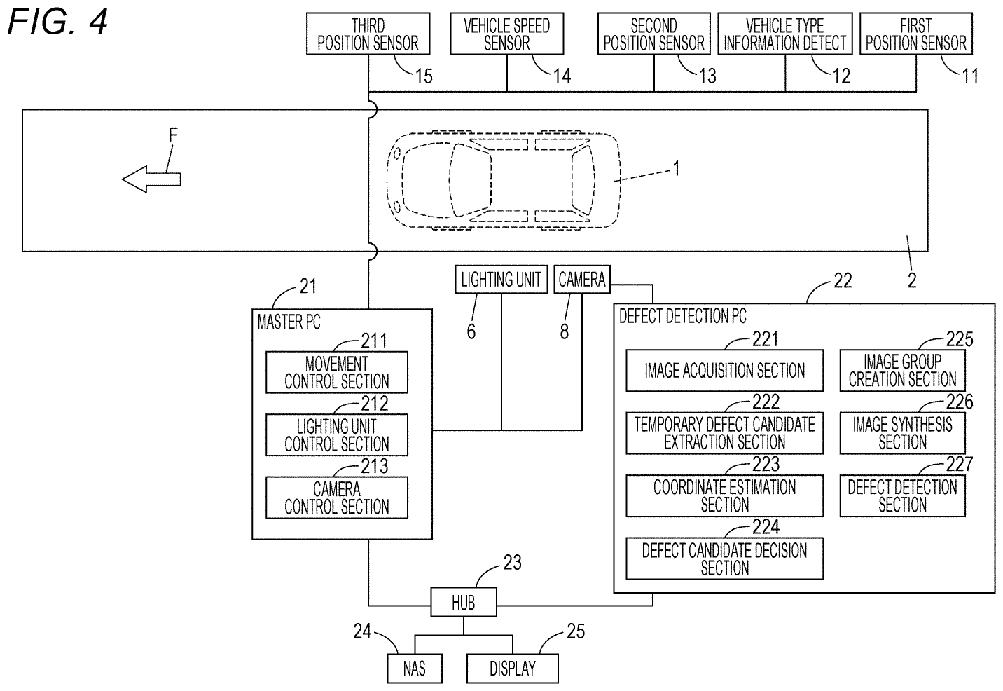

FIG. 4 is a plan view illustrating an electrical configuration of the workpiece surface inspection system illustrated in FIG. 1.

A movement region of the workpiece 1 includes a first position sensor 11, a vehicle type information detection sensor 12, a second position sensor 13, a vehicle speed sensor 14, and a third position sensor 15 in this order from the entry side along the movement direction of the workpiece 1.

The first position sensor 11 is a sensor that detects that the next workpiece 1 approaches the inspection region. The vehicle type information detection sensor 12 is a sensor that detects a vehicle ID, a vehicle type, a color, destination information, and the like of a vehicle body that becomes an inspection target. The second position sensor 13 is a sensor that detects that the workpiece 1 has entered the inspection region. The vehicle speed sensor 14 detects the movement speed of the workpiece 1 and monitors the position of the workpiece 1 by calculation, but may directly monitor the workpiece position by the position sensor. The third position sensor 15 is a sensor that detects that the workpiece 1 has exited from the inspection region.

The workpiece surface defect inspection system further includes a master PC 21, a defect detection PC 22, a HUB 23, a network attached storage (NAS) 24, and a display 25.

The master PC 21 is a personal computer that comprehensively controls the entire workpiece surface defect inspection system, and includes a processor such as a CPU, a memory such as a RAM, a storage device such as a hard disk, and other hardware and software. As one of the functions of the CPU, the master PC 21 includes a movement control section 211, a lighting unit control section 212, and a camera control section 213.

The movement control section 211 controls movement stop, movement speed, and the like of the movement mechanism 2, the lighting unit control section 212 performs lighting up control of the lighting unit 6, and the camera control section 213 performs image-capturing control of the camera 8. Image-capturing by the camera 8 is continuously performed in response to a trigger signal continuously transmitted from the master PC 21 to the camera 8.

The defect detection PC 22 is a surface defect detection device that executes surface defect detection processing, and includes a personal computer that includes a processor such as a CPU, a memory such as a RAM, a storage device such as a hard disk, and other hardware and software. As one of the functions of the CPU, the defect detection PC 22 includes an image acquisition section 221, a temporary defect candidate extraction section 222, a coordinate estimation section 223, a defect candidate decision section 224, an image group creation section 225, an image synthesis section 226, and a defect detection section 227.

The image acquisition section 221 acquires a plurality of images continuously captured in time series by the camera 8 and transmitted from the camera 8 by gigabit Ethernet (GigE). The temporary defect candidate extraction section 222 extracts a temporary defect candidate based on a plurality of images from the camera 8 acquired by the image acquisition section 221, and the coordinate estimation section 223 estimates coordinates in a subsequent image of the extracted temporary defect candidate. The defect candidate decision section 224 decides a defect candidate by performing matching between coordinates of the estimated temporary defect candidate and an actual temporary defect candidate, and the image group creation section 225 cuts out a region around the decided defect candidate and creates an image group including a plurality of images for synthesizing the images. The image synthesis section 226 synthesizes each image of the created image group into one image, and the defect detection section 227 detects and discriminates a defect from the synthetic image. Specific surface defect detection processing by these sections in the defect detection PC 22 will be described later.

The NAS 24 is a storage device on a network, and saves various data. The display 25 displays the surface defect detected by the defect detection PC 22 in a state of being associated with the position information of the vehicle body that is the workpiece 1, and the HUB 23 has a function of transmitting and receiving data to and from the master PC 21, the defect detection PC 22, the NAS 24, the display 25, and the like.

Next, defect detection processing performed by the defect detection PC 22 will be described.

A trigger signal is continuously transmitted from the master PC 21 to each camera 8 and a measured site of the workpiece 1 is continuously captured by each camera 8 in a state where the workpiece 1 is lighted from the surrounding with illumination light of a bright and dark fringe pattern by the lighting unit 6 while the workpiece 1 is moved at a predetermined speed by the movement mechanism 2. The master PC 21 sets the image-capturing interval, in other words, the interval of the trigger signal such that most of the image-capturing ranges overlap in the preceding and subsequent image-capturing. By such image-capturing, each camera 8 obtains a plurality of images in which the position of the measured site of the workpiece 1 is continuously shifted in the movement direction according to the movement of the workpiece 1.

Such a plurality of images can be obtained from the camera 8 not only in the case where only the workpiece 1 moves with respect to the fixed lighting unit 6 and the camera 8 as in the present embodiment, but also in a case where the workpiece 1 is fixed and the lighting unit 6 and the camera 8 are moved with respect to the workpiece 1, or in a case where the workpiece 1 and the camera 8 are fixed and the lighting unit 6 is moved. That is, by moving at least one of the workpiece 1 and the lighting unit 6, the bright and dark pattern of the lighting unit 6 only needs to move relative to the workpiece 1.

The plurality of images obtained by each camera 8 are transmitted to the defect detection PC 22, and the image acquisition section 221 of the defect detection PC 22 acquires the plurality of images transmitted from each camera 8. The defect detection PC 22 executes surface defect detection processing using these images.

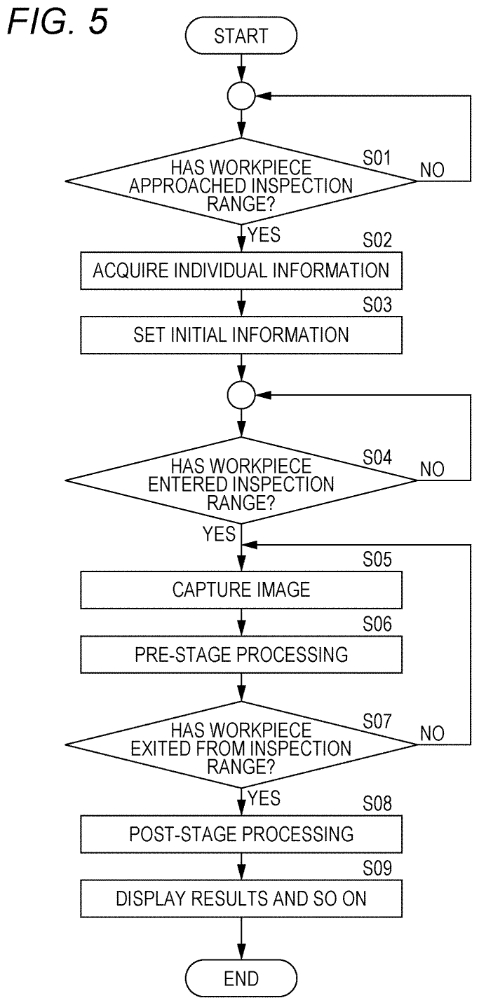

The entire processing of the workpiece surface inspection system is illustrated in the flowchart of FIG. 5.

In step S01, the master PC 21 judges whether or not the workpiece 1 has approached the inspection range based on a signal of the first position sensor 11, and if the workpiece 1 has not approached the inspection range (NO in step S01), the master PC remains in step S01. If approached (YES in step S01), in step S02, the master PC 21 acquires individual information such as a vehicle ID, an inspect target vehicle type, a color, and destination information of the vehicle that becomes an inspection target based on a signal from the vehicle type information detection sensor 12, and in step S03, sets parameters of the inspection system, e.g., and sets an inspection range on the vehicle body and the like as initial information setting.

In step S04, the master PC judges whether or not the workpiece 1 has entered the inspection range based on the signal of the second position sensor 13, and if the workpiece 1 has not entered the inspection range (NO in step S04), the master PC remains in step S04. If entered (YES in step S04), in step S05, the camera 8 captures the moving workpiece 1 in time series in a state where most of the image-capturing ranges overlap. Next, in step S06, the defect detection PC 22 performs pre-stage processing in the surface defect detection processing. The pre-stage processing will be described later.

In step S07, whether or not the workpiece 1 has exited from the inspection range is judged based on a signal of the third position sensor 15. If not exited (NO in step S07), the process returns to step S05 to continue image-capturing and the pre-stage processing. When the workpiece 1 exits from the inspection range (YES in step S07), in step S08, the defect detection PC 22 performs post-stage processing in the surface defect detection processing. That is, in this embodiment, the post-stage processing is performed after all the image-capturing of the workpiece 1 is completed. The post-stage processing will be described later.

After the post-stage processing, in step S09, a result of the surface defect detection processing is displayed on the display 25 or the like.

Next, the surface defect detection processing including the pre-stage processing of step S06 and the post-stage processing of step S08 performed by the defect detection PC 22 will be specifically described.

### [1] First Surface Defect Detection Processing

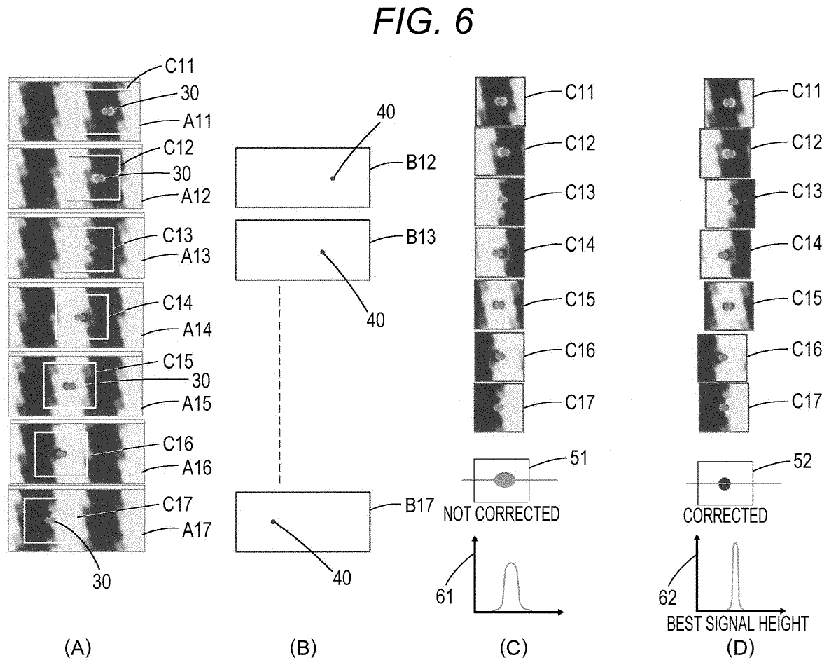

As described above, the defect detection PC 22 acquires, from each camera 8, a plurality of images in which the position of the measured site of the workpiece 1 is continuously shifted in the movement direction of the workpiece 1. This scene is illustrated in FIG. 6. A11 to A17 in FIG. 6(A) are images continuously acquired in time series from one camera 8. A bright and dark pattern in which a bright band (white part) and a dark band (black part) extending in the longitudinal direction alternately exist in the lateral direction displayed in the image corresponds to the bright and dark fringe pattern of the illumination light by the lighting unit 6.

The temporary defect candidate extraction section 222 of the defect detection PC 22 extracts a temporary defect candidate from each image. The extraction of the temporary defect candidate is executed by performing processing such as background removal and binarization, for example. In this example, it is assumed that a temporary defect candidate 30 is extracted in all the images of A11 to A17.

Next, the coordinate estimation section 223 calculates representative coordinate that is the position of the temporary defect candidate 30 for the temporary defect candidate 30 in each image having been extracted, and sets a predetermined region around the representative coordinate as a temporary defect candidate region. Furthermore, based on the movement amount of the workpiece 1, the coordinate estimation section 223 calculates as to which coordinate the calculated representative coordinate of the temporary defect candidate moves with respect to each of the subsequent images A12 to A17, and obtains the estimated coordinate in each image. The coordinate estimation section 223 calculates as to which coordinate the temporary defect candidate 30 extracted in the image A11, e.g., moves with respect to each of the subsequent images A12 to A17, and obtains the estimated coordinate in each image.

A state in which an estimated coordinate 40 of the temporary defect candidate 30 is estimated in the subsequent images A12 to A17 of the image A11 is illustrated in each image B12 to B17 of FIG. 6(B). Note that the images B12 to B17 are the same as the images from which the temporary defect candidate 30 in the images A12 to A17 has been removed. In FIG. 6(B), some images in the halfway are omitted. The bright and dark pattern appearing in the image is also omitted.

Next, the defect candidate decision section 224 performs matching between corresponding images such as the image A12 and the image B12, the image A13 and the image B13, . . . , the image A17 and the image B17 among the subsequent images A12 to A17 of the image A11 illustrated in FIG. 6(A) and the respective images B12 to B17 of FIG. 6(B) for which the estimated coordinate 40 of the temporary defect candidate 30 is obtained. The matching determines whether or not the estimated coordinate 40 corresponds to the actual temporary defect candidate 30 in the image. Specifically, the matching is performed by determining whether or not the estimated coordinate 40 is included in a predetermined temporary defect candidate region for the actual temporary defect candidate 30 in the image. Note that whether or not the estimated coordinate 40 and the actual temporary defect candidate 30 in the image correspond may be determined by determining whether or not the temporary defect candidate 30 exists in a predetermined range set in advance from the estimated coordinate 40 or determining whether or not the estimated coordinate 40 of the corresponding image exists in a predetermined range set in advance from the representative coordinate of the temporary defect candidate 30. When the estimated coordinate 40 and the temporary defect candidate 30 in the image correspond, the temporary defect candidate 30 included in the original image A11 and the temporary defect candidate 30 included in the subsequent image can be regarded as the same.

Next, as a result of the matching, the number of images in which the estimated coordinate 40 and the actual temporary defect candidate 30 in the image correspond (match) is checked, and it is judged whether or not the number is equal to or greater than a preset threshold. Then, if the number is equal to or greater than the threshold, the probability that the temporary defect candidate 30 actually exists is high, and thus the temporary defect candidate 30 of each image is decided as a defect candidate. In the examples of FIGS. 6(A) and (B), all of the subsequent images A12 to A17 of the image A11 are matched. That is, the estimated coordinate 40 is included in the temporary defect candidate region for the temporary defect candidate 30 in the image. If the number of images in which the estimated coordinate 40 and the actual temporary defect candidate 30 correspond is not equal to or greater than the preset threshold, it is considered that the possibility that the temporary defect candidate 30 is a defect candidate is not high. Therefore, the matching is stopped, and the next temporary defect candidate 30 is extracted.

Next, for all the images including the defect candidate, the image group creation section 225 cuts out a predetermined region around the representative coordinate in the defect candidate as an estimated region as surrounded by a square frame line in each of the images A11 to A17 in FIG. 6(A), and creates an estimated region image group including a plurality of estimated region images C11 to C17 as illustrated in FIG. 6(C). Note that not all the images including the defect candidate but a plurality of images among them may be used, but the larger the number of images is, the larger the information amount becomes, and it is desirable in that a highly accurate surface inspection can be performed. The estimated region may be obtained by first obtaining the estimated region of the original image A11 and calculating the position of the estimated region in each image from the movement amount of the workpiece 1.

The image synthesis section 226 superimposes and synthesizes each of the estimated region images C11 to C17 of the estimated region image group thus created, and creates one synthetic image 51 illustrated in FIG. 6(C). The superimposition is performed at the center coordinate of each of the estimated region images C11 to C17. Examples of the synthetic image 51 can include at least any of an image synthesized by calculating a statistical variation value such as a standard deviation image, a phase image, a phase difference image, a maximum value image, a minimum value image, and a mean value image. An image synthesized by calculating a statistical variation value such as a standard deviation image will be described later.

Next, the defect detection section 227 detects a surface defect using the created synthetic image 51. The detection criterion of the surface defect may be freely selected. For example, as illustrated in a signal graph 61 of FIG. 6(C), only the presence or absence of a defect may be detected by discriminating a defect if the signal is equal to or greater than a reference value. Alternatively, the type of the defect may be discriminated from comparison with a reference defect or the like. Note that the determination criteria for presence or absence of the defect and the defect type may be changed by machine learning or the like, or a new criterion may be created.

The detection result of the surface defect is displayed on the display 25. It is desirable that a development view of the workpiece (vehicle body) 1 is displayed on the display 25, and the position and the type of the surface defect are displayed on the development view in an easy-to-understand manner.

Thus, in this embodiment, the plurality of estimated region images C11 to C17 cut out from the plurality of images A11 to A17 including the defect candidate are synthesized into the one synthetic image 51, and the defect detection is performed based on this synthetic image 51, so that the synthetic image 51 includes the information on the plurality of images. Therefore, since defect detection can be performed using a large amount of information for one defect candidate, even a small surface defect can be stably detected with high accuracy while suppressing excessive detection and erroneous detection.

In a case where the number of images in which the estimated coordinate 40 and the actual temporary defect candidate 30 in the image correspond to each other is equal to or greater than the preset threshold, the synthetic image is created, and the defect detection is performed. Therefore, the defect detection can be performed in a case that the possibility that a defect exists is high, the processing load is small, the detection efficiency is improved, and the detection accuracy is also improved.

Moreover, it is not necessary to perform a plurality of different conversion processing on the fused image.

### [1-1] Modification 1 at the Time of Synthetic Image Creation

There is a case where accuracy cannot be obtained only by superimposing and synthesizing the plurality of estimated region images C11 to C17 at the center coordinate of each image.

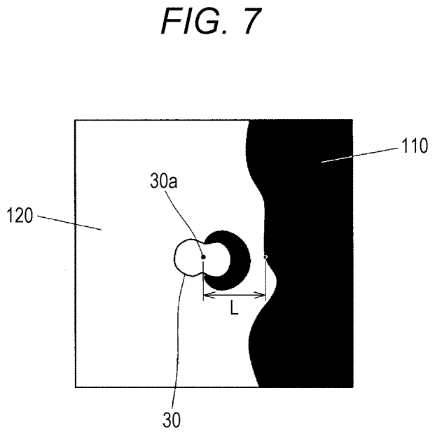

Therefore, it is desirable that the center coordinate of each of the estimated region images C11 to C17 is corrected and superimposed. An example of correction of the center coordinate is performed based on the relative position in the bright and dark pattern in each image. Specifically, in a case where a defect exists in the center of the bright band part or the dark band part of the bright and dark pattern, the shape tends to be bilaterally symmetrical. However, as an example of an estimated image C14 in FIG. 7, when the defect is close to the boundary part with a dark band part 110 in a bright band part 120, the boundary part side of the defect candidate 30 becomes dark. Reversely, when it is close to the boundary part in the dark band part 110, the boundary part side becomes bright. Therefore, e.g., when a gravity center position calculation is performed, the defect is biased from a center position 30a of the defect candidate 30. Since the biased position is correlated with the position from the boundary, the center coordinate of the image is corrected according to a position L from the boundary.

FIG. 6(D) is a view illustrating a scene of superimposing, at the center position, and synthesizing each of the estimated region images C11 to C17 of which the center position has been corrected, and creating a synthetic image 52. As compared with the synthetic image 51 and the signal graph 61 in FIG. 6(C), a sharp synthetic image 52 is obtained, and the signal height in a signal graph 62 is also high. Therefore, it is possible to create the highly accurate synthetic image 52, and eventually, it is possible to perform highly accurate surface defect detection.

### [1-2] Modification 2 at the Time of Synthetic Image Creation

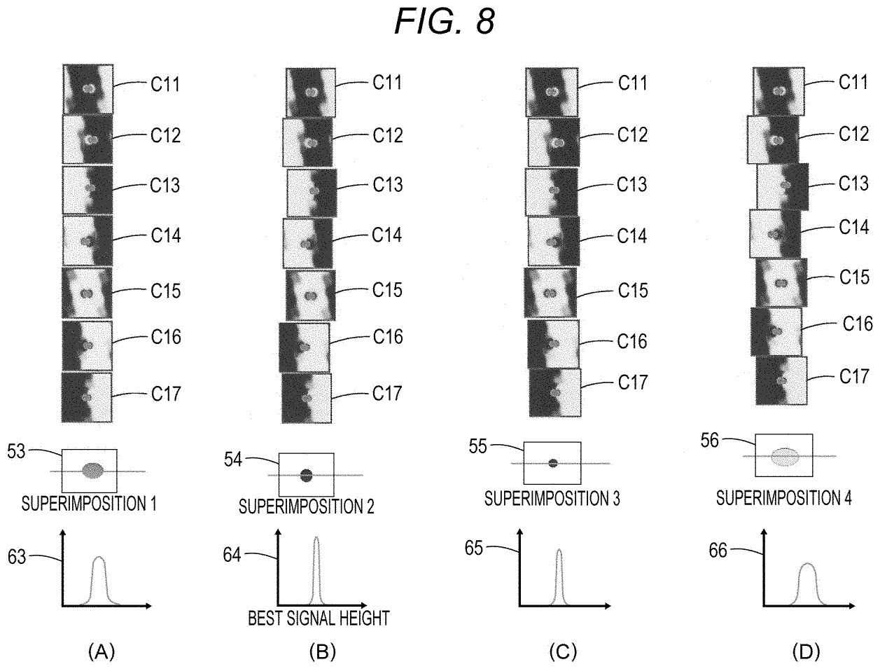

Another synthetic image creation method in a case where accuracy cannot be obtained only by superimposing and synthesizing the plurality of estimated region images C11 to C17 at the center coordinate of each image will be described with reference to FIG. 8.

Up to creation of the estimated region images C11 to C17 of FIG. 6(C) is the same. In this example, the alignment of the estimated region images C11 to C17 is attempted by a plurality of combinations in which the center coordinate of each image is shifted in at least one of the left-right direction (x direction) and the up-down direction (y direction) with various alignment amounts. Then, a combination having the maximum evaluation value is adopted from among the combinations. In FIG. 8, four types of (A) to (D) are superimposed. Each of the obtained synthetic images is illustrated in 53 to 56, and signal graphs based on the synthetic images are illustrated in 63 to 66. In the example of FIG. 8, (B) is adopted in which the highest signal is obtained.

Thus, since the alignment of the plurality of estimated region images C11 to C17 at the time of synthetic image creation is performed so that the evaluation value is maximized from among the plurality of combinations in which the center coordinate of each image is shifted in at least one of the X coordinate direction and the Y coordinate direction, it is possible to create a synthetic image with higher accuracy, and it is eventually possible to perform highly accurate surface defect detection.

### [1-3] Example of Temporary Defect Candidate Extraction Processing

An extraction processing example of a temporary defect candidate having a large size and a gentle curvature change by the temporary defect candidate extraction section 222 will be described.

First, the principle of the present method using lighting of a bright and dark fringe pattern will be described again.

The illumination light is reflected by the surface of the workpiece 1 and is incident on each pixel of the camera 8. Conversely speaking, the light incident on each pixel is light from a region where the line of sight from each pixel reaches after being reflected on the surface of the workpiece 1 in a range viewable from each pixel. A dark pixel signal is obtained without lighting, and a bright pixel signal is obtained with lighting. When the workpiece 1 is a plane without a defect, the region on the lighting corresponding to each pixel is close to a point. When there is a defect, there are two types of changes of the surface of the workpiece 1, (1) curvature change and (2) surface inclination.

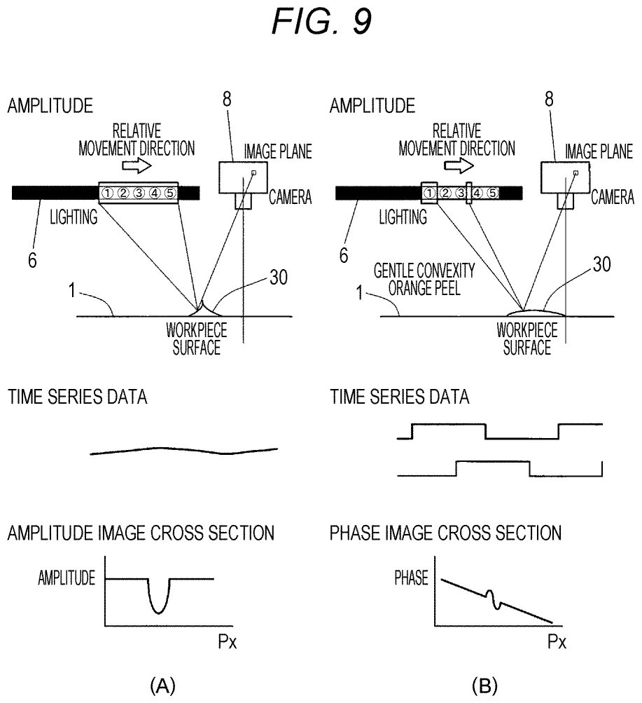

(1) As illustrated in FIG. 9(A), when the surface of the workpiece 1 has a curvature change due to the temporary defect candidate 30, the direction of the line of sight changes, but a region viewable from each pixel further widens. As a result, the region corresponding to each pixel becomes not a point but a widened region, and the average luminance in the region corresponds to the pixel signal. That is, when the shape change of the temporary defect candidate 30 is sharp, the curvature change increases in the region viewable from each pixel, and the widening of the area cannot be ignored in addition to the inclination of the line of sight. Enlargement of the viewable region is the averaging of the illumination distribution of the signal. When the region widens in the bright and dark fringe pattern illumination (in FIG. 9, the white part is bright, and the black part is dark), a mean value of both the bright and dark regions according to how the region widens is obtained. In a case where the bright and dark fringe pattern of the part where this phenomenon occurs sequentially moves, the influence can be captured in the standard deviation image.

(2) As illustrated in FIG. 9(B), when the surface of the workpiece 1 has a large curvature radius due to the temporary defect candidate 30 and is inclined while being substantially plane, the corresponding region remains as a point but faces a direction different from an uninclined surface. When the temporary defect candidate 30 is large (shape change is gentle), it is dominant that the region viewable from each pixel is the same and the line-of-sight direction changes, and the curvature change becomes gentle. The change cannot be captured in the standard deviation image. When the defect is large, a difference in inclination between the surfaces of a non-defect part and a defect part can be detected by a phase image. In the case of the non-defect part, in the phase image, the phase in the direction parallel to the fringe is the same, and the direction perpendicular to the fringe causes a certain phase change according to the period of the fringe. In the case of the defect part, the regularity of the phase is disturbed in the phase image. For example, a temporary defect candidate having a gentle curved surface change can be detected by viewing the phase images in the X direction and the Y direction.

Both of the temporary defect candidates can be extracted by two types of routines for a small temporary defect candidate and for a large temporary defect candidate defect. Any of the extracted candidates only needs to be a temporary defect candidate.

Now, consider a case where it is desired to report the size of the detected temporary defect candidate 30 as a result. The correlation between the visual defect size and the defect size detected from the image is related to an approximate circle of a part where the inclination of the plain of the defect surface becomes a predetermined angle. When the defect size is small, a certain linear relationship is observed, but the defect size is large, and a defect having a gentle plain inclination has a nonlinear relationship. Therefore, the gentle temporary defect candidate 30 detected in the phase image needs to be corrected from a separately obtained calibration curve because the defect signal and the defect size do not have a linear relationship.

### [1-4] Detection of Yarn Waste Defect

As an example of defect detection by the defect detection section 227, detection processing of a yarn waste will be described.

The yarn waste is a defect in which a thread-like foreign matter is trapped in the lower part of the painting material, and is not circular but elongated. There is one that is small in line width direction (e.g., less than 0.2 mm) but long in longitudinal direction (e.g., equal to or greater than 5 mm). Since the width direction is very narrow, it is small, and the longitudinal direction has a gentle curvature change. It may be overlooked by detection methods for small defect and for large defect (defect with gentle inclination) similar to extraction of a temporary defect candidate. After predetermined processing, it is binarized and granulated, and whether or not it is a defect is judged by the area of each part.

Since the yarn waste is narrow in width but long in length, a predetermined area can be obtained if appropriately detected. However, the yarn waste is easily detected when the longitudinal direction is parallel to the direction in which the bright and dark pattern extends, and is difficult to find when the longitudinal direction is perpendicular to the direction. A defect occurs in the longitudinal direction, and the length is shorter than the actual length, that is, the granulated area is likely to be small.

Therefore, based on the shape information on the defect obtained from the phase image, when there is a certain extension in the longitudinal direction, that is, when the roundness is lower than a predetermined value, the threshold of the area determination is reduced to suppress non-detection of yarn wastes.

### [1-5] Flowchart

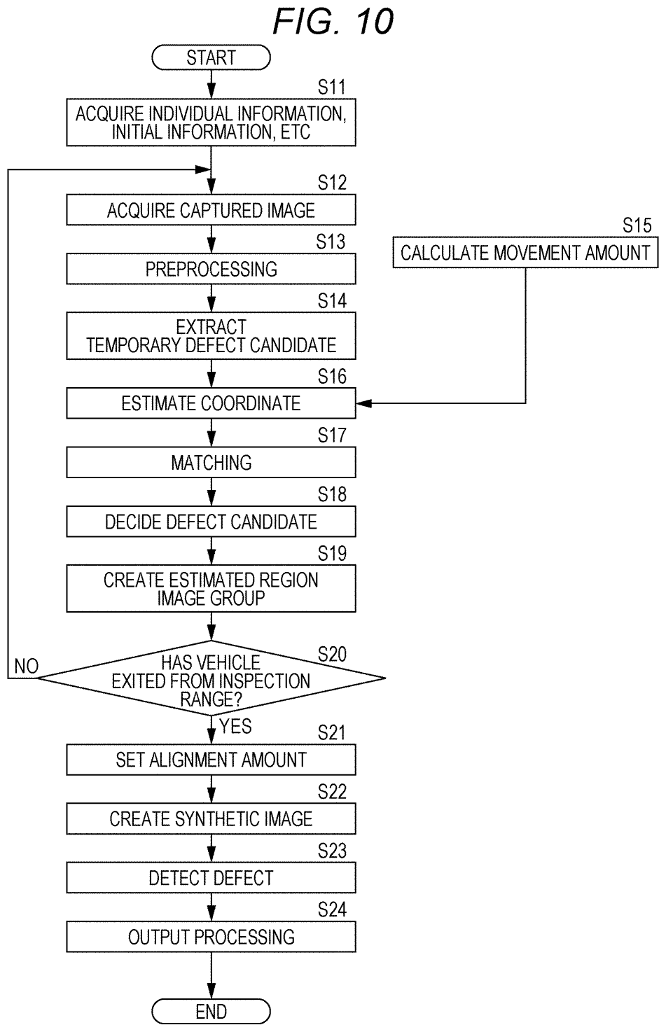

FIG. 10 is a flowchart illustrating the content of the surface defect detection processing executed by the defect detection PC 22. This surface defect detection processing presents the contents of the pre-stage processing of step S06 in FIG. 5 and the post-stage processing of step S08 in more detail. This surface defect detection processing is executed by the processor in the defect detection PC 22 operating according to an operation program stored in a built-in storage device such as a hard disk device.

In step S11, the individual information acquired by the master PC 21 in step S02 of FIG. 5 and the initial information such as the setting of the parameter set in step S03 and the setting of the inspection range on the vehicle body are acquired from the master PC 21.

Next, in step S12, an image captured by the camera 8 is acquired, and then, in step S13, preprocessing, e.g., setting of position information for the image or the like is performed based on initial setting information or the like.

After the temporary defect candidate 30 is extracted from each image in step S14, the movement amount of the workpiece 1 is calculated for one temporary defect candidate 30 in step S15, and the coordinate in the subsequent image of the temporary defect candidate 30 is estimated in step S16 to be the estimated coordinate 40.

In step S17, matching is performed. That is, it is determined whether or not the estimated coordinate 40 exist in a predetermined temporary defect candidate region for the actual temporary defect candidate 30 in the image. If the number of matched images is equal to or greater than a preset threshold, the temporary defect candidate 30 of each image is decided as a defect candidate in step S18.

In step S19, for all the images having the defect candidate, a predetermined region around the representative coordinate in the defect candidate is cut out as an estimated region, an estimated region image group including a plurality of estimated region images C11 to C17 is created, and then the process proceeds to step S20. Steps S12 to S19 are the pre-stage processing.

In step S20, whether or not the vehicle body that is the workpiece 1 has exited from the inspection range is determined based on the information from the master PC 21. If not exited from the inspection range (NO in step S20), the process returns to step S12 to continue acquisition of an image from the camera 8. If the vehicle body has exited from the inspection range (YES in step S20), the alignment amounts of each of the estimated region images C11 to C17 is set in step S21. Then, in step S22, the estimated region images C11 to C17 are synthesized to create a synthetic image, and then, in step S23, the defect detection processing is performed. Steps S21 to S23 are post-stage processing. After the defect detection, the detection result is output to the display 25 or the like in step S24.

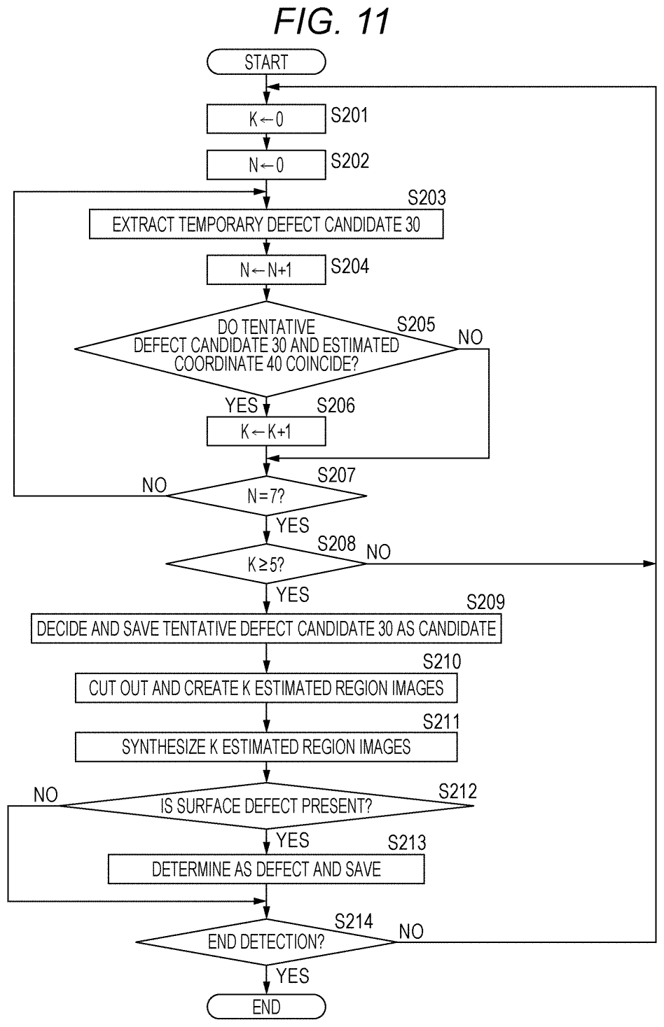

The matching processing in step S17 will be described in detail with reference to the flowchart of FIG. 11.

In step S201, K, which is a variable of the number of images matching the temporary defect candidate 30, is set to zero, and in step S202, N, which is a variable of the number of images that is a judgement target as to whether or not to match the temporary defect candidate 30, is set to zero.

After the temporary defect candidate 30 is extracted in step S203, N+1 is set to N in step S204. Next, in step S205, it is judged whether or not the temporary defect candidate 30 and the estimated coordinate 40 coincide. If coincide (YES in step S205), K+1 is set to K in step S206, and then the process proceeds to step S207. In step S205, if the temporary defect candidate 30 and the estimated coordinate 40 do not coincide (NO in step S205), the process proceeds to step S207.

In step S207, it is checked whether or not N has reached a predetermined number of images (here, 7). If not reached (NO in step S207), the process returns to step S203, and the temporary defect candidate 30 is extracted for the next image. When N reaches the predetermined number of images (YES in step S207), it is judged in step S208 whether or not K is equal to or greater than a predetermined threshold set in advance (here, 5 images). If not equal to or greater than the threshold (NO in step S208), the process returns to step S201. Therefore, in this case, cutout processing of subsequent estimated region images and image synthesis processing are not performed, N and K are reset, and the next temporary defect candidate 30 is extracted.

If K is equal to or greater than the threshold (YES in step S208), the temporary defect candidate 30 is decided as a defect candidate in step S209, the information is saved, and after that, the estimated region image is cut out from the matched K images in step S210. Then, after the cut out K estimated region images are synthesized in step S211, it is judged in step S212 whether or not a surface defect has been detected. When the surface defect is detected (YES in step S212), the surface defect is determined in step S213, the information is saved, and then the process proceeds to step S214. When the surface defect is not detected (NO in step S212), the process directly proceeds to step S214.

In step S214, it is checked whether or not the detection processing has been performed on all the inspection target sites of the workpiece. If the detection processing has not been performed (NO in step S214), the process returns to step S201, N and K are reset, and the next temporary defect candidate 30 is extracted. If the detection processing has been performed on all the inspection target sites (YES in step S214), the processing is ended.

Thus, in this embodiment, in a case where the number K of images in which the temporary defect candidate 30 and the estimated coordinate 40 correspond (match) is not equal to or greater than the threshold, there are a small number of images to be matched, and the temporary defect candidate 30 is not highly likely to be a defect candidate. Therefore, subsequent processing is stopped. If the number of images to be matched is equal to or greater than K, the temporary defect candidate 30 is highly likely to be a defect candidate. Therefore, cut out of an estimated region image, image synthesis, and defect detection are performed. Therefore, as compared with the case where cut out of an estimated region image, image synthesis, and defect detection are executed regardless of the number of matched images, the processing load is small, the detection efficiency is improved, and the detection accuracy is also improved.

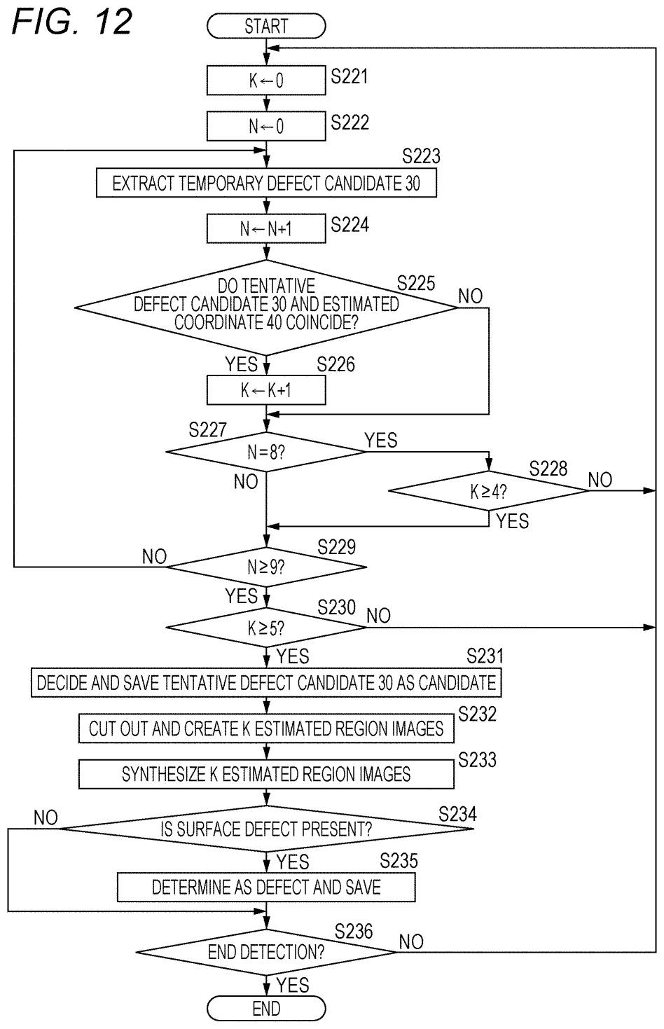

FIG. 12 is a flowchart for explaining a modification of the matching processing in step S17 of FIG. 10. In this example, in a case where the number K of matched images does not reach a certain value before the number N of images reaches a predetermined number, it is judged that the temporary defect candidate 30 is not highly likely to be a defect candidate, and subsequent processing is stopped at that time point.

In step S221, K, which is a variable of the number of images matching the temporary defect candidate 30, is set to zero, and in step S222, N, which is a variable of the number of images that is a judgement target as to whether or not to match the temporary defect candidate 30, is set to zero.

After the temporary defect candidate 30 is extracted in step S223, N+1 is set to N in step S224. Next, in step S225, it is judged whether or not the temporary defect candidate 30 and the estimated coordinate 40 coincide. If coincide (YES in step S225), K+1 is set to K in step S226, and then the process proceeds to step S227. In step S225, if the temporary defect candidate 30 and the estimated coordinate 40 do not coincide (NO in step S225), the process proceeds to step S227.

It is checked in step S227 whether or not N has reached a second predetermined number of images (here, 8). If reached (YES in step S227), it is checked in step S228 whether or not K has reached a second threshold (here, 4). If not reached (NO in step S228), the process returns to step S221. Therefore, in this case, cutout processing of subsequent estimated region images and image synthesis processing are not performed, N and K are reset, and the next temporary defect candidate 30 is extracted.

In step S228, if K has reached the second threshold (YES in step S228), the process proceeds to step S229. In step S227, if N does not reach the second predetermined number of images (eight images) (NO in step S227), the process proceeds to step S229.

In step S229, it is checked whether or not N has reached a first predetermined number of images (here, 9). If not reached (NO in step S229), the process returns to step S223, and the temporary defect candidate 30 is extracted for the next image. When N reaches the first predetermined number of images (YES in step S229), it is judged in step S230 whether or not K is equal to or greater than a preset first threshold (here, 5 images). If not equal to or greater than the first threshold (NO in step S230), the process returns to step S201. Therefore, in this case, cutout processing of subsequent estimated region images and image synthesis processing are not performed, N and K are reset, and the next temporary defect candidate 30 is extracted.

If K is equal to or greater than the first threshold (YES in step S230), the temporary defect candidate 30 is decided as a defect candidate in step S231, the information is saved, and after that, the estimated region image is cut out from the matched K images in step S232. Then, after the cut out K estimated region images are synthesized in step S233, it is judged in step S234 whether or not a surface defect has been detected. When the surface defect is detected (YES in step S234), the surface defect is determined in step S235, the information is saved, and then the process proceeds to step S236. When the surface defect is not detected (NO in step S234), the process directly proceeds to step S236.

In step S236, it is checked whether or not the detection processing has been performed on all the inspection target sites of the workpiece. If the detection processing has not been performed (NO in step S236), the process returns to step S201, N and K are reset, and the next temporary defect candidate 30 is extracted. If the detection processing has been performed on all the inspection target sites (YES in step S236), the processing is ended.

Thus, this embodiment achieves the following effects in addition to the same effects as those of the embodiment illustrated in the flowchart of FIG. 11. That is, if the number K of images in which the temporary defect candidate 30 and the estimated coordinate 40 correspond (match) has not reached the first threshold smaller than the second threshold in a stage where the number N of images from which the temporary defect candidate 30 is extracted is a first set value smaller than a second set value, that is, in a middle stage, it is judged that the number of images to be matched is small and the temporary defect candidate 30 is not highly likely to be a defect candidate, and the matching processing is not continued until the final image and the subsequent processing is stopped. Therefore, since unnecessary processing is not continued, the processing load can be further reduced, and the detection accuracy can be further improved.

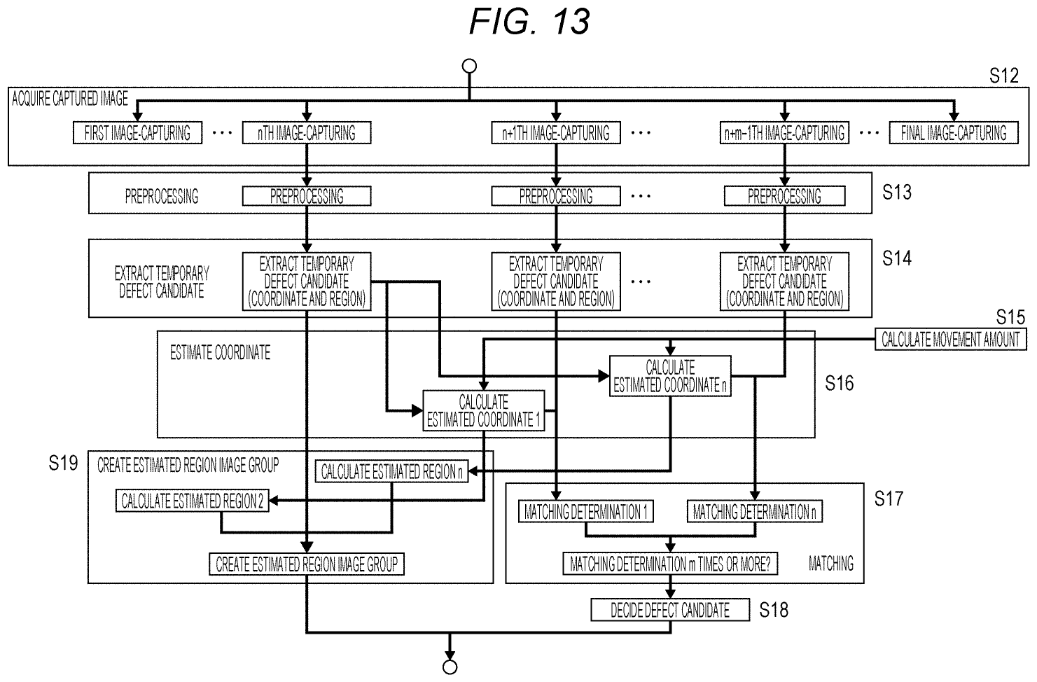

FIG. 13 is a flowchart illustrating details of steps S12 to S18 of the flowchart of FIG. 10, which is pre-stage processing in the surface defect detection processing, and the same processing as in the flowchart of FIG. 10 is given the same step number.

Image-capturing is continuously performed by the camera 8 while the workpiece 1 is moved from one workpiece 1 enters the inspection range and until it exits from the inspection range, and the defect detection PC 22 acquires in step S12 images from the first image-capturing to the last. Here, assuming that images in which one temporary defect candidate 30 is captured are images from the n-th image-capturing to the (n+m−1)-th image-capturing.

After each image is preprocessed in step S13, the temporary defect candidate 30 is extracted in step S14 for each image from the n-th image-capturing to the (n+m−1)-th image-capturing, and the representative coordinate and the temporary defect candidate region of the extracted temporary defect candidate 30 are obtained. Furthermore, based on the movement amount calculation of the workpiece 1 in step S15, it is calculated in step S16 as to which coordinate the representative coordinate of the temporary defect candidate moves with respect to each of the subsequent images, and the estimated coordinate 40 in each image is obtained.

In step S17, matching is performed for each subsequent image. If the number of images that are matched is equal to or more than a threshold (e.g., m), the temporary defect candidate 30 is determined as a defect candidate in step S18. In step S19, an estimated region is calculated for each image, and an estimated region image group including the plurality of estimated region images C11 to C17 is created.

### [2] Second Surface Defect Detection Processing

In the first surface defect detection processing, the defect detection PC 22 extracts the temporary defect candidate 30 from the images continuously acquired in time series from the camera 8.

An extraction method of the temporary defect candidate 30 is not limited, but a configuration in which the temporary defect candidate 30 is extracted by performing the following processing is desirable in that the defect site is emphasized and the temporary defect candidate 30 can be extracted with higher accuracy.

That is, binarization processing is performed on each of the images A11 to A17 (illustrated in FIG. 6) acquired from the camera 8, and then the threshold is applied thereto, or a corner detection function is applied thereto, thereby extracting a feature point of the image. Then, the temporary defect candidate 30 may be extracted by obtaining a multidimensional feature amount for each extracted feature point.

More desirably, before extraction of a feature point, each image acquired from the camera 8 is binarized, the outline is extracted, and then the images expanded and contracted a predetermined number of times are subtracted, thereby creating an orange peel mask for removing the boundary part between the bright band and the dark band. It is preferable to extract the feature point of each image after the boundary part between the bright band and the dark band is masked by applying this created mask, and it is thus possible to more accurately extract the temporary defect candidate.

The extraction of the temporary defect candidate 30 may be performed by, after the extraction of the feature point of the image, obtaining the multidimensional feature amount based on the luminance gradient information in all the longitudinal, lateral, and oblique directions from the pixel for all the pixels in the surrounding specific range with respect to each extracted feature point.

After the extraction of the temporary defect candidate 30, an estimated region image group including the plurality of estimated region images C11 to C17 is created similarly to the first surface defect detection processing described above, and then defect detection is performed for each temporary defect candidate using this estimated region image group.

Thus, in the second surface defect detection processing, the feature point of an image is extracted for the plurality of images in which the position of the measured site of the workpiece 1 acquired from the camera 8 is continuously shifted, and the multidimensional feature amount is obtained with respect to each extracted feature point, whereby the temporary defect candidate 30 is extracted. Therefore, the temporary defect candidate 30 can be extracted highly accurately, and eventually, the surface defect can be detected highly accurately.

Moreover, the coordinate of the extracted temporary defect candidate 30 is obtained, the estimated coordinate 40 is obtained by calculating to which coordinate the coordinate of the temporary defect candidate 30 moves with respect to each of a plurality of images subsequent to the image from which the temporary defect candidate 30 is extracted, it is determined whether or not the estimated coordinate 40 corresponds to the temporary defect candidate 30 in the image, and when the number of images in which the estimated coordinate 40 corresponds to the temporary defect candidate of the subsequent image is equal to or greater than a preset threshold, the temporary defect candidate 30 is decided as a defect candidate. Then, for each decided defect candidate, a predetermined region around the defect candidate is cut out as an estimated region from a plurality of images including the defect candidate, an estimated region image group including the plurality of estimated region images C11 to C17 is created, and defect discrimination is performed based on the created estimated region image group.

That is, since the plurality of estimated region images C11 to C17 including the defect candidate includes the plurality of pieces of information regarding one defect candidate, the defect detection can be performed using more pieces of information. Therefore, even a small surface defect can be stably detected with high accuracy while suppressing excessive detection and erroneous detection.

### [2-1] Flowchart

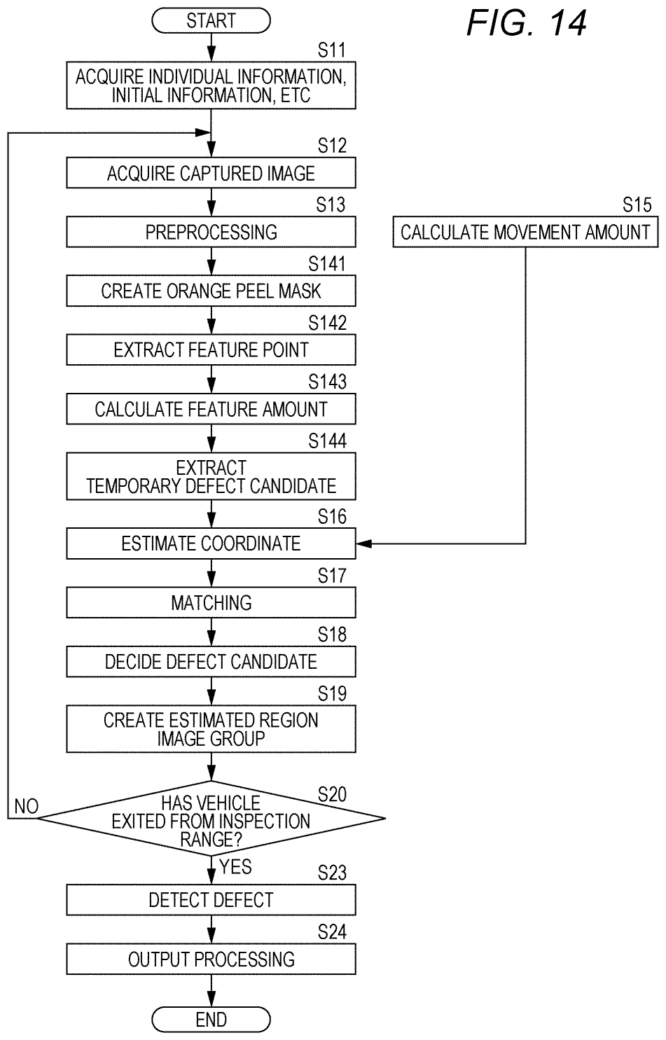

FIG. 14 is a flowchart illustrating second surface defect detection processing executed by the defect detection PC. Note that steps S11 to S13 and steps S15 to S20 are the same as steps S11 to S13 and steps S15 to S20 in FIG. 10, and therefore the same step numbers are given and description thereof is omitted.

After the preprocessing in step S13, an orange peel mask is created in step S141, and a feature point is extracted in step S142 by applying the created orange peel mask.

Next, in step S143, a multidimensional feature amount is calculated for each extracted feature point, and the temporary defect candidate 30 is extracted in step S144, and then the process proceeds to step S16.

If the vehicle body, which is the workpiece 1, exits from the inspection range in step S20 (YES in step S20), the defect discrimination processing is executed in step S23 using the created estimated region image group, and the discrimination result is displayed in step S24.

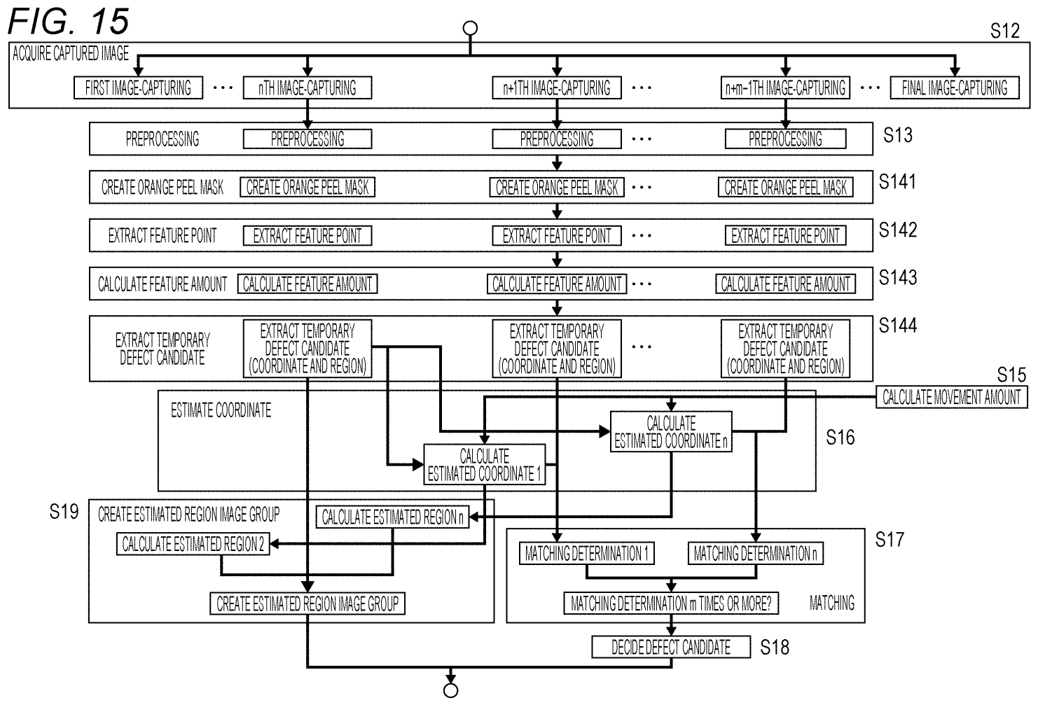

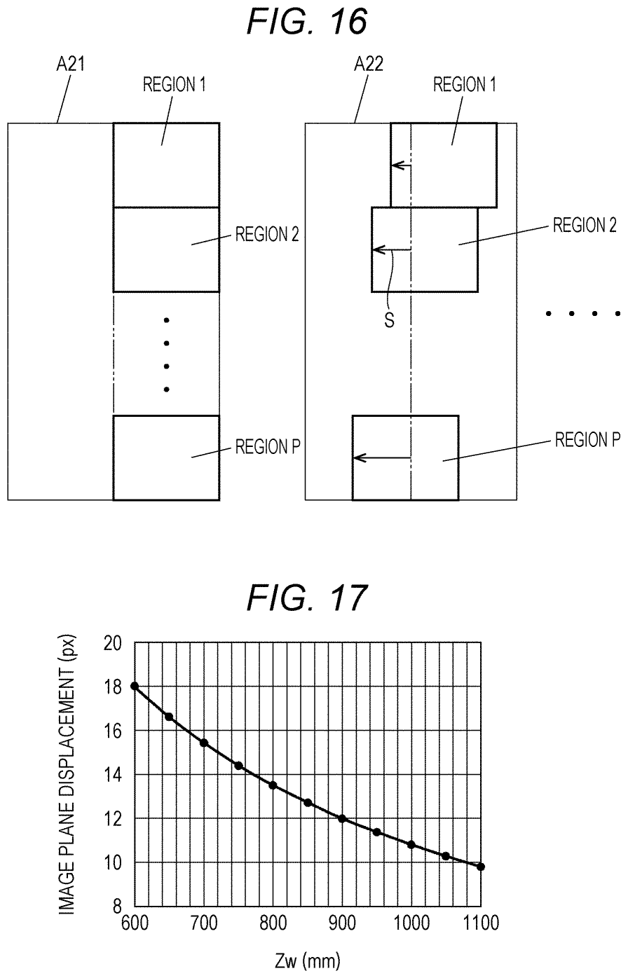

FIG. 15 is a flowchart illustrating details of steps S12 to S18 of the flowchart of FIG. 14, and the same processing as in the flowchart of FIG. 14 is given the same step number. Note that steps S12, S13, and S15 to S19 are the same as the processing in steps S12, S13, and S15 to S19 in FIG. 13, and thus description thereof is omitted.

After the preprocessing in step S13, each orange peel mask for each image is created in step S141. In step S142, the created orange peel mask is applied to each image to extract a feature point of each image.

In step S143, a multidimensional feature amount is calculated for each feature point of each extracted image, and in step S144, a temporary defect candidate is extracted for each image, and then the process proceeds to step S16.

### [3] Third Surface Defect Detection Processing

In the first surface defect detection processing described above, after the temporary defect candidate 30 is extracted in each of the images A11 to A17, the defect candidate is determined, the estimated region around the defect candidate is calculated, and the plurality of estimated region images C11 to C17 are synthesized to perform the defect detection.

On the other hand, in the third surface defect detection processing, a plurality of continuous time-series images acquired from the camera 8 are each divided into a plurality of regions, and a plurality of preceding and subsequent images are synthesized in corresponding regions, and after that, the defect is detected. However, since the workpiece 1 is moving, the image-capturing range of the workpiece 1 indicated by the region of the preceding image is not the same as the image-capturing range of the workpiece 1 indicated by the region of the subsequent image, and the image-capturing position is different according to the movement amount of the workpiece 1. Therefore, the position of the region of the subsequent image with respect to the region of the preceding image is shifted by the position shift amount according to the movement amount of the workpiece 1 and synthesized. Since the position shift amount between the region of the preceding image and the corresponding region of the subsequent image varies depending on the position of the divided region, the position shift amount according to the movement amount of the workpiece 1 is set for each divided region.

Although described in detail below, the plurality of images continuously captured by the camera 8 and continuously acquired in time series by the defect detection PC 22 are the same as the images acquired in the first surface defect detection processing.

FIG. 16 illustrates a plurality of images A21 and A22 continuously acquired in time series. Although two images are illustrated in this example, the number of images is greater in reality. In the images A21 and A22, bright and dark patterns appearing in the images are omitted. These images A21 and A22 are divided into a plurality of regions 1 to p in a direction (up-down direction in FIG. 16) orthogonal to the movement direction of the workpiece. The regions 1 to p have the same size at the same position (same coordinate) in the images A21 and A22.

Since the workpiece is moving, e.g., the image-capturing range corresponding to an image in each of the regions 1 to p in the image A21, for example, acquired from the camera 8 is shifted in position in the movement direction by the movement amount of the workpiece 1 with respect to the original regions 1 to p as indicated by arrows in the subsequent next image A22. Therefore, by shifting the position of each of the regions 1 to p in the image A22 by a position shift amount S according to the movement amount of the workpiece, the regions 1 to p in the image A21 and the respective regions 1 to p after the position shift of the image A22 become the same image-capturing range on the workpiece 1. Since such a relationship occurs between the regions 1 to p in the preceding and subsequent captured images, the image-capturing ranges of the regions 1 to p of the original image A21 and the subsequent images can be matched by sequentially shifting the regions 1 to p in the subsequent images by the position shift amount S.

However, as schematically illustrated in the image A22 of FIG. 16, the shift amount with respect to the original regions 1 to p is different for each of the regions 1 to p. For example, in a case where a linear part and a curved part of the workpiece 1 exist in an image-capturing range by one camera 8, the position shift amounts of the region corresponding to the linear part and the region corresponding to the curved part in the image are not the same. It is also different because of the distance to the camera 8. Therefore, even if all the regions 1 to p are shifted by a uniform position shift amount, the same image-capturing range is not necessarily obtained depending on the region.

Therefore, in this embodiment, the position shift amount S is calculated and set for each of the regions 1 to p. Specifically, average magnification information in each of the regions 1 to p is obtained from camera information, camera position information, three-dimensional shape of the workpiece, and position information of the workpiece. Then, the position shift amount S is calculated for each of the regions 1 to p from the obtained magnification information and the approximate movement speed assumed in advance, and is set as the position shift amount S for each of the regions 1 to p.

Here, the calculation of the position shift amount will be supplemented. A case where a plurality of images of the moving workpiece 1 are captured at equal time intervals will be considered. Attention is paid to how a same point moves between two consecutive captured images.

The movement amount on the image is related to the image-capturing magnification of the camera and the speed of the workpiece. The image-capturing magnification of the camera depends on (1) the lens focal length and (2) the distance from the camera to each part of the workpiece to be captured. Regarding (2), on the image, a part close to the camera has a greater movement amount than a part far from the camera has. When the 3D shape of the workpiece 1, the installation position of the camera 8, and the position and orientation of the workpiece 1 are known, it is possible to calculate where the attention point in an image captured at a certain moment appears.

When the workpiece 1 moves and the position changes, it is possible to calculate how many pixels' equivalent the same attention point moves on two consecutive images. For example, when considering a case where the workpiece moves by 1.7 mm between adjacent images with a sensor having a focal length of 35 mm and a pixel size of 5.5 μm, a distance (Zw) to the workpiece 1 is 600 to 1100 mm as illustrated in the graph of FIG. 17, and therefore the movement distance in the screen is 18 pixels to 10 pixels.

If the alignment error required for synthetic image creation is suppressed to ±1 pixel, the distance difference only needs to be set to ±5 cm. The region is divided on the image such that the distance difference from the camera becomes within ±5 cm. For each of the divided regions, an average position shift amount between consecutive images is calculated from an approximate movement speed of the workpiece 1. For each of the regions 1 to p, it is possible to set three types of position shift amounts, i.e., the position shift amount and the shift amount of ±1 pixel. However, the position shift amount is not limited to three types, and the distance difference is not limited to ±5 cm.

The position shift amount S for each of the regions 1 to p having been set is stored in association with the regions 1 to p in a table of a storage unit in the defect detection PC 22, and is set by calling the position shift amount from the table for an image-capturing site in which the same position shift amount can be set, e.g., the same shape part of the workpiece 1 and the same type of workpiece.

Next, a predetermined number of consecutive images are synthesized for each of the plurality of regions 1 to p in a state where the position of each of the regions 1 to p is shifted by the set position shift amount S. In the synthesis, the images of each of the regions 1 to p are superimposed in a state where the positions of each of the regions 1 to p are shifted by the set position shift amount S, and calculation is performed for each pixel of corresponding coordinates in the superimposed image, thereby creating a synthetic image for each pixel. Examples of the synthetic image include at least any of an image synthesized by calculating a statistical variation value such as a standard deviation image, a phase image, a phase difference image, a maximum value image, a minimum value image, and a mean value image.

Next, preprocessing such as background removal and binarization is performed on, e.g., a standard deviation image, which is a synthetic image, a defect candidate is extracted, and after that, a surface defect is detected using a calculation or a synthetic image different from those of the processing at the time of defect candidate extraction as necessary. The detection criterion of the surface defect may be freely selected, and only the presence or absence of the defect may be discriminated, or the type of the defect may be discriminated from comparison with a reference defect or the like. Note that the discrimination criteria for presence or absence of the defect and the defect type only need to be set according to the characteristics of the workpiece and the defect and may be changed by machine learning or the like, or a new criterion may be created.

The detection result of the surface defect is displayed on the display 25. It is desirable that a development view of the workpiece (vehicle body) is displayed on the display 25, and the position and the type of the surface defect are displayed on the development view in an easy-to-understand manner.

Thus, in this embodiment, the plurality of captured images A21 and A22 continuously acquired in time series from the camera are divided into the plurality of regions 1 to p, the plurality of images are synthesized for each of the divided regions 1 to p, and the defect detection is performed based on this synthetic image, so that the synthetic image includes information on the plurality of images. Therefore, since defect detection can be performed using a large amount of information for one defect candidate, even a small surface defect can be stably detected with high accuracy while suppressing excessive detection and erroneous detection.

Moreover, since the images of the corresponding regions are synthesized in a state where the regions 1 to p of the subsequent image A22 are sequentially shifted with respect to the regions 1 to p of the preceding image A21 by the position shift amount S set according to the movement amount of the workpiece 1, the region of the preceding image and the corresponding region of the subsequent image become the same image-capturing range of the workpiece 1, and it is possible to synthesize a plurality of images in a state where the image-capturing ranges of the workpiece 1 are matched. Since the position shift amount is set for each of the divided regions 1 to p, it is possible to minimize an error in the image-capturing range as compared with a case where a uniform position shift amount is applied to all the divided regions 1 to p. Therefore, surface defects can be detected with higher accuracy.

### [2-1] Modification 1 Regarding Position Shift Amount

In the above example, the position shift amount S corresponding to each of the divided regions 1 to p is calculated for each of the regions 1 to p from magnification information of each of the regions 1 to p and an approximate movement speed assumed in advance, but the position shift amount S may be set from a result of setting a plurality of position shift amounts for each of the regions 1 to p.

For example, for each of the regions 1 to p, position shift amount candidates are set under a plurality of conditions from a slow speed to a fast speed including an assumed movement speed. Then, each position shift amount candidate is applied to create a synthetic image, defect detection is further performed as necessary, and the position shift amount S with the highest evaluation is adopted from the comparison.

Thus, a plurality of position shift amount candidates are set under different conditions for each of the regions 1 to p, and the position shift amount candidate having the highest evaluation is adopted as the position shift amount S for each of the regions 1 to p from the comparison when the images are synthesized with the position shift amount candidates. Therefore, it is possible to set the position shift amount S suitable for each of the regions 1 to p, and it is possible to detect the surface defect with higher accuracy.

### [2-2] Modification 2 Regarding Position Shift Amount

The position shift amount S for each of the regions 1 to p may be set as follows. That is, when the movement distance of the workpiece 1 between adjacent images is known as in the graph of FIG. 17, the position shift amount on the image can be calculated. In the above-mentioned example, the position shift amount is set based on the workpiece movement speed assumed in advance.

The appropriate position shift amount for each frame at the time of synthetic image creation may be determined based on the actually measured workpiece position. In this case, it is possible to save time and effort to select an optimum position shift amount from a plurality of position shift amounts.

A measurement method of the workpiece position will be described as follows. The workpiece 1 or a same site of a support member that moves in the same manner as the workpiece 1 is captured by a plurality of position-dedicated cameras arranged in the movement direction of the workpiece 1, and position information of the workpiece is obtained from the image First, a characteristic hole if the workpiece 1 has any, or a mark installed on a table that holds and moves the workpiece 1 is used as a target for position or speed measurement of the workpiece 1.

In order to detect the target, a plurality of cameras different from the camera 8 are prepared. For example, they are arranged in a line in the traveling direction of the workpiece 1 so as to view the workpiece side face from the side of the workpiece 1. They are arranged such that the lateral visual fields of the plurality of them cover the entire length of the workpiece 1 when the lateral visual fields are connected. The magnification can be calculated from the distance from the camera to the workpiece 1 and the focal length of the camera. Based on the magnification, the actual position is obtained from the position on the image. The position relationship among the cameras is known, and the position of the workpiece 1 is obtained from the image information of each camera.

By associating the workpiece position information from the plurality of cameras, an appropriate position shift amount is obtained from the image of the camera 8 for defect extraction. For each region virtually divided on the workpiece 1 such that a distance difference on the workpiece viewed from the camera becomes ±5 cm, for example, an average movement amount on the image between adjacent images according to the movement amount of the workpiece 1 is determined, and a synthetic image is created as the position shift amount at the time of superimposition.

### [2-3] Modification 3 Regarding Position Shift Amount

In the second modification, the position of the workpiece is obtained using a plurality of cameras arranged. Instead, the workpiece 1 or a same site of a support member that moves in the same manner as the workpiece 1 may be measured by a measurement system including any of a distance sensor, a speed sensor, and a vibration sensor in a singular or combined manner to obtain the workpiece position information.

A measurement method of the workpiece position will be described. A part of the workpiece 1 or a same site of a support member that moves in the same manner as the workpiece 1 is targeted. Detection of the workpiece position uses “a sensor that detects reference point passage of the workpiece position+a distance sensor” or “a sensor that detects reference point passage+a speed sensor+an image-capturing time interval of adjacent images”. The former directly gives the workpiece position. The latter gives the workpiece position when each image is captured by multiplying the speed information from the speed sensor by the image-capturing interval.

By associating the workpiece position information described above, an appropriate position shift amount is obtained from the image of the camera 8 for defect extraction. For each region virtually divided on the workpiece 1 such that a distance difference on the workpiece viewed from the camera becomes ±5 cm, for example, an average movement amount on the image between adjacent images according to the movement amount of the workpiece 1 is determined, and a synthetic image is created as the position shift amount at the time of superimposition.

### [2-4] Flowchart

The entire processing of the workpiece surface inspection system is performed according to the flowchart illustrated in FIG. 5.

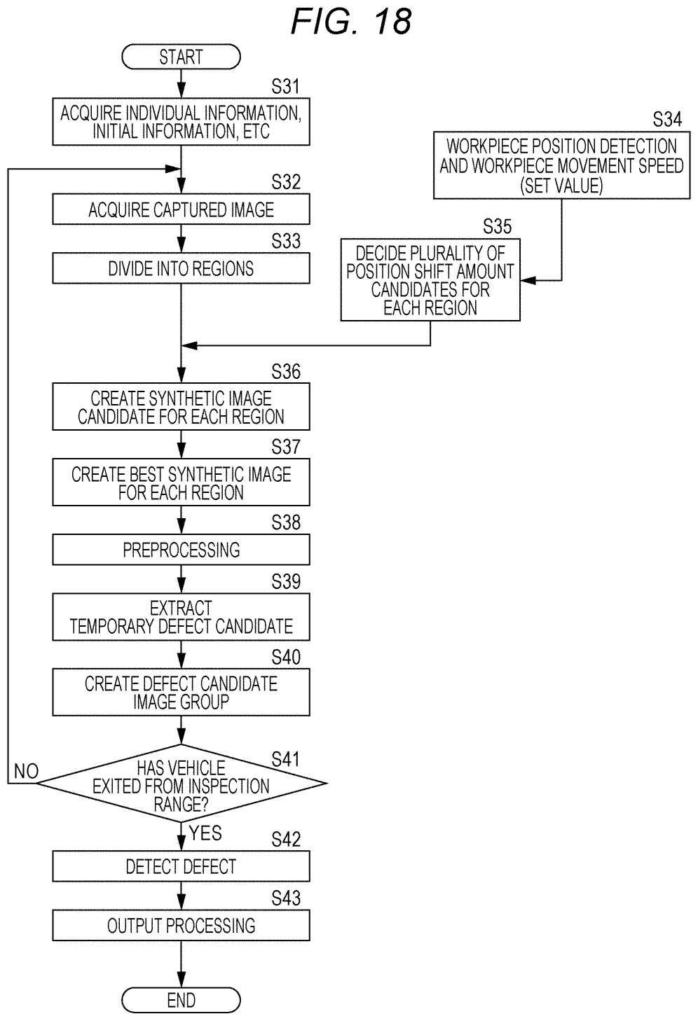

FIG. 18 is a flowchart illustrating contents of third surface defect detection processing executed by the defect detection PC 22. This surface defect detection processing presents the contents of the pre-stage processing of step S06 in FIG. 5 and the post-stage processing of step S08 in more detail. This surface defect detection processing is executed by the processor in the defect detection PC 22 operating according to an operation program stored in a built-in storage device such as a hard disk device.

In step S31, the individual information acquired by the master PC 21 in step S02 of FIG. 5 and the initial information such as the setting of the parameter set in step S03 and the setting of the inspection range on the vehicle body are acquired from the master PC 21.

Next, after the images A21 and A22 captured by the camera 8 are acquired in step S32, each of the images A21 and A22 is divided into the plurality of regions 1 to p in step S33. On the other hand, based on the position and the movement speed (step S34) of the workpiece 1, a plurality of position shift amount candidates is set for each of the divided regions 1 to p in step S35.

Next, in step S36, a plurality of images of which positions are shifted by a plurality of position shift amount candidates are synthesized for one region, and a plurality of synthetic image candidates are created for each region. Thereafter, in step S37, the position shift amount candidate with the highest evaluation is set as the position shift amount with respect to the regions 1 to p from the comparison of the synthetic images for each of the created position shift amount candidates, and the plurality of images are synthesized again for each region by the position shift amount to create the synthetic image.

In step S38, preprocessing such as background removal and binarization is performed on the synthetic image, and then a defect candidate is extracted in step S39. By performing such processing for each of the plurality of regions 1 to p and for each of a predetermined number of images, a large number of defect candidate image groups from which defect candidates are extracted are created in step S40, and then the process proceeds to step S41. Steps S32 to S40 are the pre-stage processing.

In step S41, whether or not the vehicle body has exited from the inspection range is determined based on the information from the master PC 21. If not exited from the inspection range (NO in step S41), the process returns to step S32 to continue acquisition of an image from the camera 8. If the vehicle body has exited from the inspection range (YES in step S41), the defect detection processing is performed on the defect candidate image group in step S42. Step S42 is post-stage processing. After the defect detection, the detection result is output to the display 25 or the like in step S43.

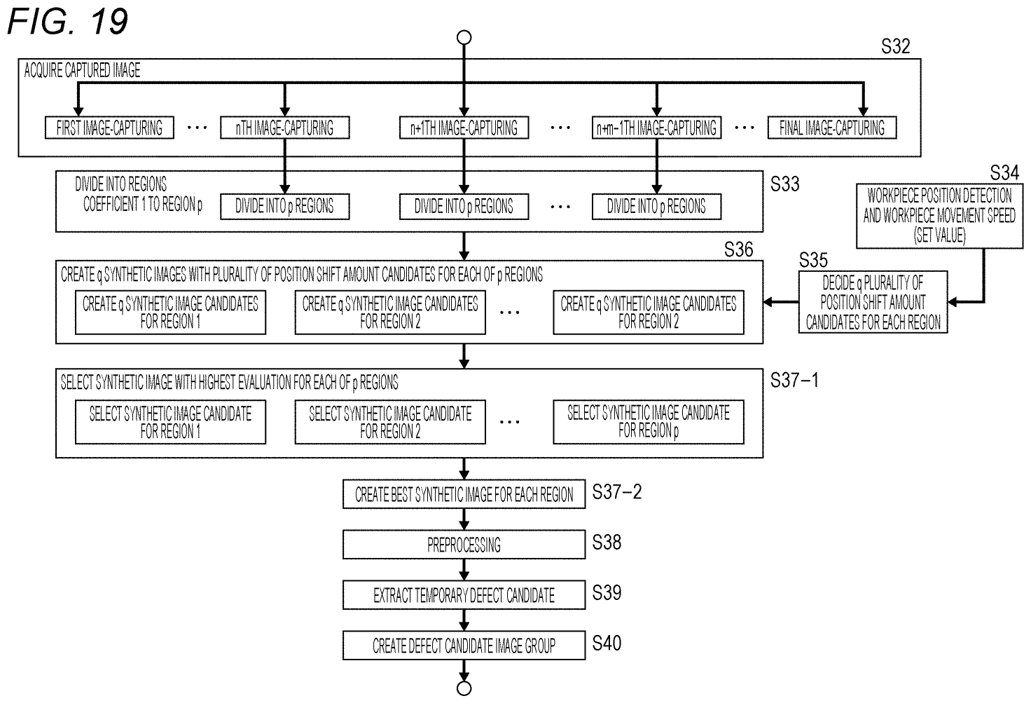

FIG. 19 is a flowchart illustrating details of steps S32 to S40 of the flowchart of FIG. 18, which is pre-stage processing in the surface defect detection processing, and the same processing as in the flowchart of FIG. 18 is given the same step number.

Image-capturing is continuously performed by the camera 8 while the workpiece 1 is moved from one workpiece 1 enters the inspection range and until it exits from the inspection range, and the defect detection PC 22 acquires in step S32 images from the first image-capturing to the last image-capturing. Here, a case of use of images from the n-th image-capturing to the (n+m−1)-th image-capturing will be exemplified.

In step S33, each image is divided into p image regions of regions 1 to p, for example. In step S35, q position shift amount candidates are set for each of the p regions. In step S36, q synthetic image candidates are created by applying q position shift amount candidates for each of the p image regions. That is, q synthetic images are created for each of the regions 1 to p.

In step S37-1, the synthetic image having the highest evaluation value is selected for each of the regions 1 to p, and the position shift amount candidates corresponding to the selected synthetic image is decided as the position shift amount for the image region.

Then, a synthetic image is created by applying the decided position shift amount for each of the regions 1 to p in step S37-2.

Subsequent preprocessing (step S38), defect candidate extraction processing (step S39), and defect candidate image group creation processing (step S40) are similar to those in FIG. 18, and thus description thereof is omitted.

### [4] Creation of Standard Deviation Image and the Like

In the first surface defect detection processing and the third surface defect detection processing, when the workpiece is moved in a state where the workpiece is irradiated with the bright and dark lighting pattern, a plurality of images of synthesis target are created based on a plurality of images in which image-capturing ranges captured in time series by the camera 8 overlap, and the plurality of images are synthesized into one image to obtain a synthetic image. As one of this synthetic image, an image synthesized by calculating a statistical variation value such as a standard deviation image can be considered.

Statistical variation values include at least any of a variance, a standard deviation, and a half width. Any calculation may be performed, but a case where the standard deviation is calculated for synthesis will be described here.

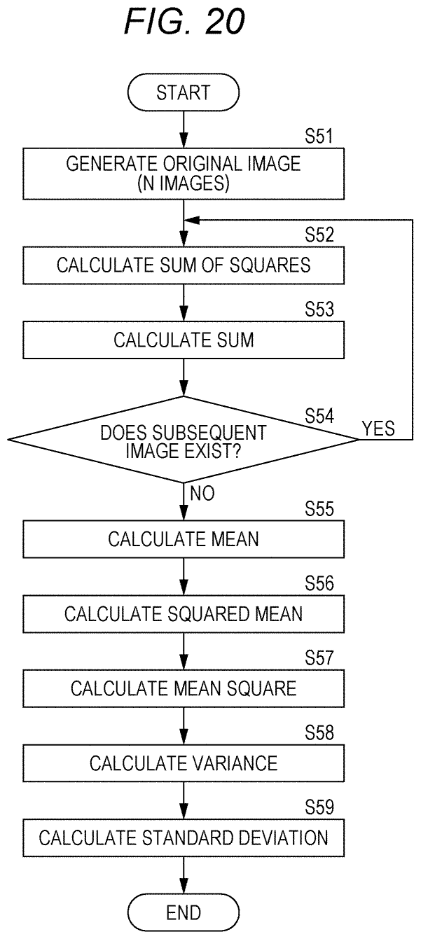

The standard deviation is calculated for each corresponding pixel of the plurality of images. FIG. 17 is a flowchart illustrating creation processing of a standard deviation image. Note that the processing illustrated in the flowcharts of FIG. 20 and thereafter is executed by the defect detection CPU operating according to an operation program stored in the storage unit or the like.

In step S51, the original images (N images) that become synthesis targets are generated. In step S52, the sum of squares of the luminance value (hereinafter, also referred to as pixel value) is calculated for each pixel with respect to the first original image After that, the sum of pixel values is calculated for each pixel in step S53. In the first image, the sum of squares and the sum calculation are the results only for the first image.

Next, it is checked in step S54 whether or not there is a next image. If there is (YES in step S54), the process returns to step S52, and the pixel value of each pixel of the second image is squared and added to the square value of each corresponding pixel value of the first image. Next, in step S53, each pixel value of the second image is added to each corresponding pixel value of the first image.

Such processing is sequentially performed on the N images, and the sum of squares of the pixel values and the sum of the pixel values are calculated for each corresponding pixel of the N images.

Upon completion of the processing for the N images (NO in step S54), the mean of the sums of the pixel values calculated in step S53 is calculated in step S55. After that, the squared mean of the sums is calculated in step S56.

Next, in step S57, the mean square, which is the mean value of the sums of squares of the pixel values calculated in step S52, is calculated. After that, in step S57, the variance is obtained from the formula {(mean square)−(squared mean)}. Then, in step S59, the standard deviation, which is the square root of the variance, is obtained.

The thus obtained standard deviation is desirably normalized, and a synthetic image is created based on the result. If the variance or the half width is used as the statistical variation value, the same calculation may be performed.

The surface defect detection processing is performed based on the created synthetic image. The detection processing only needs to be performed similarly to the first surface defect detection processing and the third surface defect detection processing.

Thus, since the synthetic image is created by calculating the statistical variation value and synthesizing corresponding pixels of a plurality of images and applying this to all the pixels, it is possible to create a synthetic image having a high S/N ratio for defect detection even when the number of images that become synthesis target is small, and it is possible to perform highly accurate defect detection by using this synthetic image, to reduce detection of unnecessary defect candidates, and to prevent overlooking of detection of necessary defects. Moreover, the cost becomes lower than that in a case of creating a synthetic image using a maximum value, a minimum value, or the like.

### [4-1] Another Embodiment 1 Regarding Standard Deviation Image

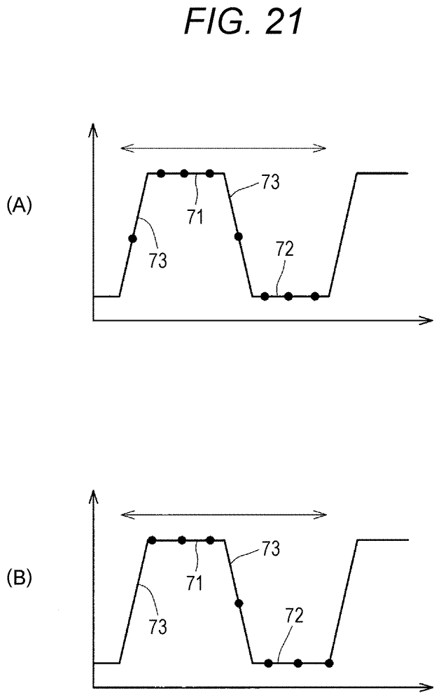

FIG. 18 illustrates a graph of illuminance for the workpiece 1 of the lighting unit 6 that lights with a bright and dark pattern. In the graph of FIG. 21, a top part 71 of the waveform indicates a bright band, and a bottom part 72 indicates a dark band.

The rising and falling parts 73 of the waveform from the bright band to the dark band or from the dark band to the bright band are not perpendicular in reality and are inclined. In an image part corresponding to a midpoint of each of the rising and falling parts 73, the pixel value has an intermediate gradation, which affects the variation.

In a case where image-capturing is performed a plurality of times in one cycle of the lighting pattern, e.g., assuming that image-capturing is performed eight times as indicated by the black circles in FIG. 21(A), there is a high possibility that two pixels of eight pixels in each of the obtained eight images become pixel values having an intermediate gradation corresponding to the midpoint. On the other hand, assuming that image-capturing is performed seven times at the timing indicated by the black circles in FIG. 21(B), there is a high possibility that at least one pixel of seven pixels in each of the obtained seven images becomes a pixel value having an intermediate gradation corresponding to the midpoint.

As described above, such a pixel value of the intermediate gradation affects variation, resulting in deterioration of defect detection accuracy. Therefore, it is desirable that the pixel value of such intermediate gradation is excluded from the sampling candidates of the variation calculation, and the variation is calculated only for the selected optimal sampling candidate. Specifically, when the number of original images that become synthesis targets in one cycle of the lighting pattern is an even number, the variation is preferably calculated by thinning out two pixel values of the intermediate gradation from the pixel values of the plurality of pixels. When the number of original images is an odd number, the variation is preferably calculated by thinning out one pixel value of the intermediate gradation from the pixel values of the plurality of pixels. Thus, by excluding the pixel value of the intermediate gradation from the sampling candidates for the variation calculation and performing the variation calculation only for the selected optimal sampling candidate, the statistical variation value is calculated only by the optimal sampling candidate, and the influence of the pixel excluded from the sampling candidates can be suppressed. Therefore, even when the number of images to be synthesized is small, it is possible to create a synthetic image, capable of performing highly accurate defect detection.

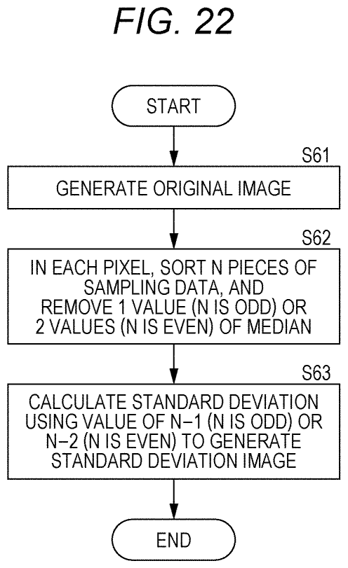

FIG. 22 is a flowchart illustrating processing of generating a standard deviation image by excluding the pixel value of the intermediate gradation from the sampling candidates for the variation calculation and performing the variation calculation only for the selected optimal sampling candidate.

After a plurality of (N) original images are generated in step S61, sampling data that are pixel values for the N images are sorted in each pixel of each image, and one median value (N is an odd number) or two median values (N is an even number) are removed in step S62.

Next, in step S63, the standard deviation is calculated with values of N−1 (N is an odd number) or N−2 (N is an even number) for each pixel.

The thus obtained standard deviation is desirably normalized, and a synthetic image is created based on the result. If the variance or the half width is used as the statistical variation value, the same calculation may be performed.

### [4-2] Another Embodiment 2 Regarding Standard Deviation Image

Also in this embodiment, image-capturing is performed a plurality of times (N times) for one cycle of the lighting pattern. N times may be a small number.

In this embodiment, similarly to the case of another embodiment 1 regarding the standard deviation image, the standard deviation is calculated with N−1 pieces of sampling data (pixel values) for each pixel when the number of original images of the synthesis target in one cycle of the lighting pattern is an odd number, and is calculated with N−2 pieces of sampling data when the number of original images is an even number. That is, in the case of an odd number, the standard deviation is calculated with N−1 combinations (NCN−1)) selected from N pixel values for each pixel. In the case of an even number, the standard deviation is calculated with N−2 combinations (NCN−2)) selected from N pixel values for each pixel. Then, from among (NCN−1)) or (NCN−2)) combinations of standard deviations obtained for each pixel, the maximum standard deviation is decided as the standard deviation for the pixel (maximum value processing).

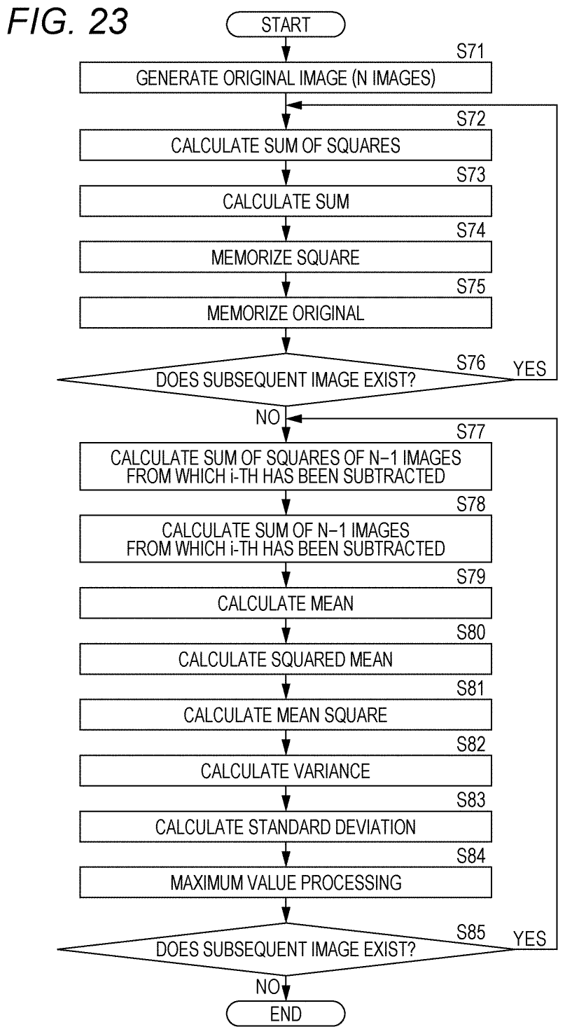

The above processing is illustrated in the flowchart of FIG. 23. In the processing of FIG. 23, the case where the number N of original images that become synthesis target is an odd number is presented, but the same applies to the case of an even number.

In step S71, the original images (N images) that become synthesis targets are generated. In step S72, the sum of squares of the pixel value is calculated for each pixel with respect to the first original image. After that, the sum of pixel values is calculated for each pixel in step S73. In the first image, the sum of squares and the sum calculation are the results only for the first image. In step S74, the square value of each pixel value of the first image is stored. In step S75, each pixel value (original) of the first image is stored.

Next, it is checked in step S76 whether or not there is a next image. If there is (YES in step S76), the process returns to step S72, and the pixel value of each pixel of the second image is squared and added to the square value of each corresponding pixel value of the first image. Next, in step S73, each pixel value of the second image is added to each corresponding pixel value of the first image. Furthermore, in step S74, the square value of each pixel value of the second image is stored. In step S75, each pixel value (original) of the second image is stored.

Such processing is sequentially performed on the N images, and the sum of squares of the pixel values and the sum of the pixel values are calculated for each corresponding pixel of the N images The square value and the pixel value (original) of each image value of each of the N images are stored.

Upon completion of the processing for the N images (NO in step S76), the square value of each pixel of the first image (i=1), with i as a variable, is first subtracted in step S77 from the sum of squares of the pixel value of each pixel in all the N images calculated in step S72, and the sum of squares of N−1 images is calculated for each pixel.

Next, in step S78, each pixel value of the first image is subtracted from the sum of the pixel values of all the images calculated in step S73, and the sum of N−1 images is calculated. In step S79, the mean of the sums of N−1 images calculated in step S78 is calculated. After that, the squared mean of the sums is calculated in step S80.

Next, in step S81, the mean square, which is the mean value of the sums of squares of N−1 images calculated in step S77, is calculated. After that, in step S82, the variance is obtained from the formula {(mean square)−(squared mean)}. Then, in step S83, the standard deviation, which is the square root of the variance, is obtained.

Next, maximization processing is performed in step S84. Here, since only one standard deviation has been obtained for each pixel, this value is the maximum.

Next, in step S85, it is checked whether or not there is a next image to be subtracted, in other words, whether or not i=N, and if there is the next image, that is, if i=N is not true (YES in step S85), the process returns to step S77, i=2 is set, the sum of squares of the pixel values and the pixel value of the second image are subtracted, the standard deviation is similarly calculated, and the maximization processing is performed in step S85. In the maximization processing, the standard deviation when the first image is subtracted is compared with the standard deviation when the second image is subtracted, and the larger standard deviation is adopted.

Thus, the sum of squares and pixel values of each image until i=N is reached, i.e., from the first image to the N-th image are sequentially subtracted to calculate the standard deviation for each pixel, and the maximum standard deviation is adopted as the standard deviation of the pixel.

The thus obtained standard deviation is desirably normalized, and a synthetic image is created based on the result. If the variance or the half width is used as the statistical variation value, the same calculation may be performed.

In this embodiment, since a predetermined number of images are excluded from the calculation target sequentially from the plurality of images, and the statistical variation value of each pixel is calculated, the optimal sampling candidate can be easily selected. Moreover, since the maximum value of the calculated variation value is adopted as the variation value for the pixel, a synthetic image having a higher S/N ratio can be created.

In this embodiment, a case where a plurality of images are acquired in one cycle of a bright and dark pattern by the lighting unit 6 while the workpiece 1 is relatively moved at a predetermined speed with respect to the lighting unit 6 and the camera has been described.

However, a plurality of images in one cycle of the lighting pattern may be acquired by relatively moving only the lighting unit 6 with respect to the workpiece 1 and the camera 8, and, based on these plurality of images, a synthetic image in which variation such as a standard deviation is calculated may be created.

### INDUSTRIAL APPLICABILITY

The present invention can be used to detect a surface defect of a workpiece such as a vehicle body, for example.

### REFERENCE SIGNS LIST

1 workpiece
2 movement mechanism
3 lighting frame
4 support base
6 lighting unit
7 camera frame
8 camera
21 master PC
22 defect detection PC
30 temporary defect candidate
40 estimated coordinate
221 image acquisition section
222 temporary defect candidate extraction section
223 coordinate estimation section
224 defect candidate decision section
225 image group creation section
226 image synthesis section
227 defect detection section

1. A workpiece surface defect detection device comprising:
a hardware processor that
creates a synthetic image by calculating a statistical variation value in a plurality of images using the plurality of images obtained by the hardware processor continuously capturing a workpiece in a state where the workpiece is illuminated by a lighting device that causes a periodic luminance change at a same position of the workpiece that is a detection target of a surface defect, the plurality of images being obtained in one period of the periodic luminance change, and
detects a defect based on a synthetic image created by the hardware processor.

2. The workpiece surface defect detection device according to claim 1, wherein the statistical variation value is at least any of a variance, a standard deviation, and a half width.

3. The surface defect detection device according to claim 1, wherein the hardware processor performs calculation of the statistical variation value for each pixel and performs calculation for an optimal sampling candidate selected for each pixel of the plurality of images.

4. The surface defect detection device according to claim 3, wherein the hardware processor calculates a variation value after excluding, from the plurality of images, a sampling value of an intermediate gradation that becomes a variation value reduction factor in each pixel, and adopts the variation value as a variation value for the pixel.

5. A workpiece surface inspection system comprising:
a lighting device that causes a periodic luminance change at a same position of a workpiece that is a detection target for a surface defect;
a hardware processor that continuously captures the workpiece in a state where the workpiece is illuminated by the lighting device; and
the workpiece surface defect detection device according to claim 1.

6. A workpiece surface defect detection method, wherein
a workpiece surface defect detection device executes
creating a synthetic image by calculating a statistical variation value in a plurality of images using the plurality of images obtained by a hardware processor continuously capturing a workpiece in a state where the workpiece is illuminated by a lighting device that causes a periodic luminance change at a same position of the workpiece that is a detection target of a surface defect, the plurality of images being obtained in one period of the periodic luminance change, and
detecting a defect based on a synthetic image created by the creating.

7. The workpiece surface defect detection method according to claim 6, wherein the statistical variation value is at least any of a variance, a standard deviation, and a half width.

8. The workpiece surface defect detection method according to claim 6, wherein in the creating, calculation of the statistical variation value is performed for each pixel, and is performed for an optimal sampling candidate selected for each pixel of the plurality of images.

9. The workpiece surface defect detection method according to claim 8, wherein in the creating, a variation value is calculated after excluding, from the plurality of images, a sampling value of an intermediate gradation that becomes a variation value reduction factor in each pixel, and is adopted as a variation value for the pixel.

10. A non-transitory recording medium storing a computer readable program for causing a computer to execute the workpiece surface defect detection method according to claim 6.

11. The surface defect detection device according to claim 2, wherein the hardware processor performs calculation of the statistical variation value for each pixel and performs calculation for an optimal sampling candidate selected for each pixel of the plurality of images.

12. A workpiece surface inspection system comprising:
a lighting device that causes a periodic luminance change at a same position of a workpiece that is a detection target for a surface defect;
a hardware processor that continuously captures the workpiece in a state where the workpiece is illuminated by the lighting device; and
the workpiece surface defect detection device according to claim 2.

13. A workpiece surface inspection system comprising:
a lighting device that causes a periodic luminance change at a same position of a workpiece that is a detection target for a surface defect;
a hardware processor that continuously captures the workpiece in a state where the workpiece is illuminated by the lighting device; and
the workpiece surface defect detection device according to claim 3.

14. A workpiece surface inspection system comprising:
a lighting device that causes a periodic luminance change at a same position of a workpiece that is a detection target for a surface defect;
a hardware processor that continuously captures the workpiece in a state where the workpiece is illuminated by the lighting device; and
the workpiece surface defect detection device according to claim 4.

15. The workpiece surface defect detection method according to claim 7, wherein in the creating, calculation of the statistical variation value is performed for each pixel, and is performed for an optimal sampling candidate selected for each pixel of the plurality of images.

16. A non-transitory recording medium storing a computer readable program for causing a computer to execute the workpiece surface defect detection method according to claim 7.

17. A non-transitory recording medium storing a computer readable program for causing a computer to execute the workpiece surface defect detection method according to claim 8.

18. A non-transitory recording medium storing a computer readable program for causing a computer to execute the workpiece surface defect detection method according to claim 9.
